(19) United States
(12) Patent Application Publication
(10) Pub. No.: US 2004/0268233 A1
(43) Pub. Date: Dec. 30, 2004

(54) Information processing apparatus and information processing method

(75) Inventors: Akihiro Okumura, Saitama (JP); Atsushi Ikeno, Kyoto (JP); Yasuko Matsumura, Hyogo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/603,987

(22) Filed: Jun. 26, 2003

(30) Foreign Application Priority Data
Jun. 27, 2002 (JP) JP2002-187622
Jun. 27, 2002 (JP) JP2002-187625
Nov. 28, 2002 (JP) JP2002-345885
Jan. 30, 2003 (JP) JP2003-021979

(51) Int. Cl. G06F 17/00

(52) U.S. Cl. 715/513

(57) ABSTRACT

An information processing apparatus and an information processing method capable of accurately, efficiently determining a key region from a structured document which includes a plurality of regions without imposing operation burden on a user are provided. The information processing apparatus for determining a key region from a structured document including a plurality of regions, includes: a read section acquiring contents or management information of the regions included in said structured document at time series for a plurality of number of times; a storage section storing the contents or management information of the regions acquired by the read section; a comparison and check section comparing the contents or management information of the corresponding regions among the contents or management information of the regions acquired by the read section, and checking whether each of the regions has been updated based on a comparison result; an update frequency calculation section calculating update frequency information for each of the regions based on a history of a check result of the comparison and check section; and a key region determination section determining the key region from the plurality of regions included in said structure document based on the update frequency information.

### BACKGROUND OF THE INVENTION

The present invention relates to an information processing apparatus and an information processing method and can be applied to, for example, a case of acquiring a structured document from a WWW (World Wide Web) site.

### DESCRIPTION OF THE RELATED ART

As a tool for acquiring and viewing a structured document present in a WWW site, there is known a WWW browser. Normally, it is possible to flexibly designate the document layout, character size and the like on each page of the structured document. In addition, as shown in FIG. 1, the page (frame page) of the structured document which page consists of a plurality of regions (frame) including a title (region Aa), links to other structured documents (region Ab) and a body (region Ac) can be displayed on the WWW browser.

In order to acquire desired information from the structured document using the WWW browser, a user first designates the URL (Uniform Resource Identifier)/URL (Uniform Resource Locator) of the target structured document. After the target structured document is displayed on the WWW browser, the user visually searches the desired information while scrawling a screen (manual search). At this time, the user appropriately utilizes the character string search function of the WWW browser. Japanese Patent Application Laid-Open No. 10-187753 (to be referred to as “Patent Document 1” hereinafter) discloses a WWW information extraction system for automatically extracting user's desired information from a plurality of structured documents. This WWW information extraction system has a function of scrapping information (e.g., the region Ac shown in FIG. 1) included in each of the structured documents, combining pieces of information thus scrapped into one document and providing the resultant document to a user. This function makes it possible to decrease user's work load required for information extraction.

However, according to the WWW information extraction system disclosed by Patent Document 1, the user is required to manually designate the range (a start point to an end point) of the structured documents in which range the desired information is described, to the system in advance. In extracting the desired information from the structure documents in large quantities, in particular, the load of the user disadvantageously grows.

Further, if a plurality of frame pages having different forms of divided regions (different frame structures) are an information extraction target, there is a high probability that the user should re-designate an information extraction range per frame page, whereby the convenience of the system to the user is disadvantageously deteriorated.

### SUMMARY OF THE INVENTION

The present invention has been achieved to solve these conventional disadvantages. It is an object of the present invention to provide a novel, improved information processing apparatus and a novel, improved information processing method capable of accurately, efficiently determining a key region from a predetermined structured document which includes a plurality of regions without imposing operation burden on a user.

To attain the object, according to the first aspect of the present invention, there is provided an information processing apparatus for determining a key region from a predetermined structured document including a plurality of regions. This information processing apparatus is characterized by including: a read section acquiring contents or management information of the regions included in the structured document at time series for a plurality of number of times; a storage section storing the contents or management information of the regions acquired by the read section; a comparison and check section comparing the contents or management information of the corresponding regions among the contents or management information of the regions acquired by the read section, and checking whether each of the regions has been updated based on a comparison result; an update frequency calculation section calculating update frequency information for each of the regions based on a history of a check result of the comparison and check section; and a key region determination section determining the key region from the plurality of regions included in the structure document based on the update frequency information.

To attain the object, according to the second aspect of the present invention, there is provided an information processing method for determining a key region from a predetermined structured document including a plurality of regions. This information processing method is characterized in that a read section acquires contents or management information of the regions included in the structured document at time series for a plurality of number of times; a storage section stores the contents or management information of the regions acquired by the read section; a comparison and check section compares the contents or management information of the corresponding regions among the contents or management information of the regions acquired by the read section, and checks whether each of the regions has been updated based on a comparison result; an update frequency calculation section calculates update frequency information for each of the regions based on a history of a check result of the comparison and check section; and a key region determination section determines the key region from the plurality of regions included in the structure document based on the update frequency information.

To attain the object, according to the third aspect of the present invention, there is provided an information processing apparatus for determining a key region from a structured document. This information processing apparatus is characterized by including: a read section acquiring the structured document regularly or irregularly; a division section dividing the structured document acquired and read by the read section into one or a plurality of regions; a division result storage section temporarily storing a division result of the division section; a comparison section comparing a content of the structured document acquired by the read section at one reading time with the content of the structured document acquired at a different reading time for each of the regions, and thereby checking whether each of the regions has been updated; an update information storage section storing update information for each of the regions; an update frequency calculation section calculating a new update frequency for each of the regions based on a previous update frequency of the each region and newly acquired information on update of the each region; and a determination section determining that the region having a highest update frequency as the key region.

To attain the object, according to the fourth aspect of the present invention, there is provided an information processing apparatus for determining a key region from a structured document. This information processing apparatus is characterized by including: a read section acquiring the structured document regularly or irregularly; a division section dividing the structured document acquired and read by the read section into one or a plurality of regions; a storage section temporarily storing a read result of the read section; a comparison section comparing a content of the structured document acquired by the read section at one reading time with the content of the structured document acquired at a different reading time for each of the regions, and thereby checking whether each of the regions has been updated; an update information storage section storing update information for each of the regions; an update frequency calculation section calculating a new update frequency for each of the regions based on a previous update frequency of the each region and newly acquired information on update of the each region; and a determination section determining that the region having a highest update frequency as the key region.

To attain the object, according to the fifth aspect of the present invention, there is provided an information processing apparatus for determining a key region from a structured document. This information processing apparatus is characterized by including: a read section acquiring the structured document regularly or irregularly; a division section dividing the structured document acquired and read by the read section into one or a plurality of regions; a conversion section converting a content of each of the divided regions into converted data; a storage section temporarily storing the converted data obtained by converting the content of each of the regions; a comparison section comparing the converted data obtained from the structured document and acquired by the read section at one reading time with the converted data obtained from the structured document and acquired at a different reading time, and thereby checking whether each of the regions has been updated; an update information storage section storing update information for each of the regions; an update frequency calculation section calculating a new update frequency for each of the regions based on a previous update frequency of the each region and newly acquired information on update of the each region; and a determination section determining that the region having a highest update frequency as the key region.

To attain the object, according to the sixth aspect of the present invention, there is provided an information processing apparatus for selecting a key region from a predetermined structured document including a plurality of regions. This information processing apparatus is characterized by including: an attribute information generation section analyzing a control character designating a display structure of the structured document, and generating attribute information on each of the regions; and a key region select section selecting the key region from among the plurality of regions by comparing the attribute information of the regions.

To attain the object, according to the seventh aspect of the present invention, there is provided an information processing method for selecting a key region from a predetermined structured document including a plurality of regions. This information processing method is characterized in that an attribute information generation section analyzing a control character designating a display structure of the structured document, and generating attribute information on each of the regions; and a key region select section selecting the key region from among the plurality of regions by comparing the attribute information of the regions.

The present invention can automatically, efficiently and accurately select a key region from a structured document.

### BRIEF DESCRIPTION OF THE DRAWINGS

FIG. 1 is an explanatory view showing an example of the configuration of a structured document used in the first and second embodiments according to the present invention;

FIG. 2 is a schematic diagram showing an example of the configuration of a region processing section in the first embodiment;

FIG. 3 is a flow chart showing the operation of the region processing section at the time of “information update” in the first embodiment;

FIGS. 4A to 4D are explanatory views showing an example of a structured document used in the description of the operation in the first embodiment;

FIG. 5 is an explanatory view showing an example of the result of reading the respective files of the structured documents shown in FIGS. 4A to 4D;

FIG. 6 is an explanatory view showing an example of dividing the structured document shown in FIG. 5;

FIG. 7 is a flow chart showing the operation of the region processing section at the time of “output of the content of an important region” in the first embodiment;

FIG. 8 is a flow chart showing a method for calculating an update frequency S in the first embodiment;

FIG. 9 is a table showing a concrete example of calculating the update frequencies S in the first embodiment;

FIG. 10 is a table showing a concrete example of calculating the update frequencies S in the first embodiment;

FIG. 11 is a flow chart if the operations of the region processing section at the time of “information update” and at the time of “output of the content of the important region” in the first embodiment are combined;

FIG. 12 is a schematic diagram showing an example of the configuration of a region processing section in the second embodiment according to the present invention;

FIG. 13 is a flow chart showing the operation of the region processing section at the time of “information update” in the second embodiment;

FIG. 14 is a flow chart showing a method for calculating the update frequency S in the second embodiment;

FIG. 15 is an explanatory view showing an example of the configuration of a structured document in the third to fifth embodiments according to the present invention;

FIG. 16 is a block diagram showing the functional configuration of a region processing section in the third embodiment;

FIG. 17 is an explanatory view showing an example of input data input to the region processing section in the third embodiment;

FIG. 18 is an explanatory view showing an example of the record extraction result of a region extraction section in the third embodiment;

FIG. 19 is an explanatory view showing an example of the output result of the region processing section in the third embodiment;

FIG. 20 is a block diagram showing the functional configuration of a region processing section in the fourth embodiment;

FIG. 21 is an explanatory view showing the record extraction result of a region extraction section in the fourth embodiment;

FIG. 22 is a block diagram showing the functional configuration of a region processing section in the fifth embodiment;

FIG. 23 is an explanatory view showing the record extraction result of a region extraction section in the fifth embodiment;

FIG. 24 is a schematic diagram showing an example of the overall configuration of a communication system in the first to fifth embodiments;

FIG. 25 is a schematic diagram showing an example of the configuration of a communication terminal in the first to fifth embodiments; and

FIG. 26 is a schematic diagram showing an example of the configuration of a WWW server in the first to fifth embodiments.

### DETAILED DESCRIPTION OF THE PREFERRED EMBODIMENTS

The preferred embodiments of an information processing apparatus and an information processing method according to the present invention will be described hereinafter in detail with reference to the accompanying drawings. It is noted that constituent elements almost equal in function and constitution are denoted by the same reference symbols, respectively in the following description as well as the accompanying drawings.

### First Embodiment

FIG. 24 shows the configuration of a communication system 10 in the first embodiment. This communication system 10 includes a network 11, a communication terminal 12 and a WWW server 13.

A LAN (Local Area Network) or Internet can be used as the network 11. This embodiment will be described while assuming that the network 11 is the Internet.

The WWW server 13 has a function of returning files which constitute a WWW page as a response (HTTP response) to a request (HTTP request) from the communication terminal 12 when receiving the request. Generally, the WWW server 13 is accompanied by a database (not shown) which accumulates WWW pages and the like generated in advance and a database server which manages the database. Further, network equipment such as a router and a firewall and various servers such as a DNS (Domain Name System) server and an FTP (File Transfer Protocol) server are arranged around the WWW server 13 and the database server, thus constituting a WWW site.

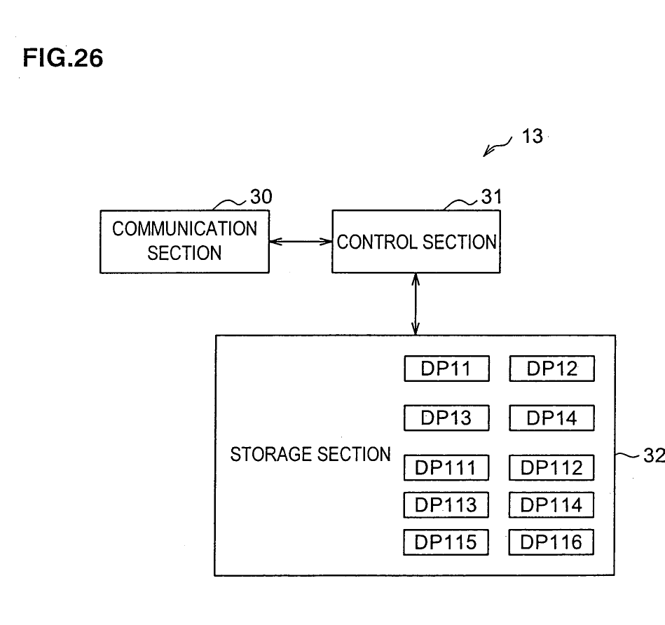

As shown in FIG. 26, the WWW server 13 in this embodiment includes a communication section30, a control section 31 and a storage section 32.

The communication section 30 functions to communicate with the communication terminal 12 and the other devices through the network 11.

The control section 31 corresponds to a CPU (Central Processing Unit) of a WWW server 13 in terms of hardware and an OS (Operating System) and a WWW server software in terms of software. If the WWW server 13 is accompanied by the database for accumulating WWW pages and the like generated in advance, if necessary, a DBMS (Data Base Management System) is also mounted on the control section 31.

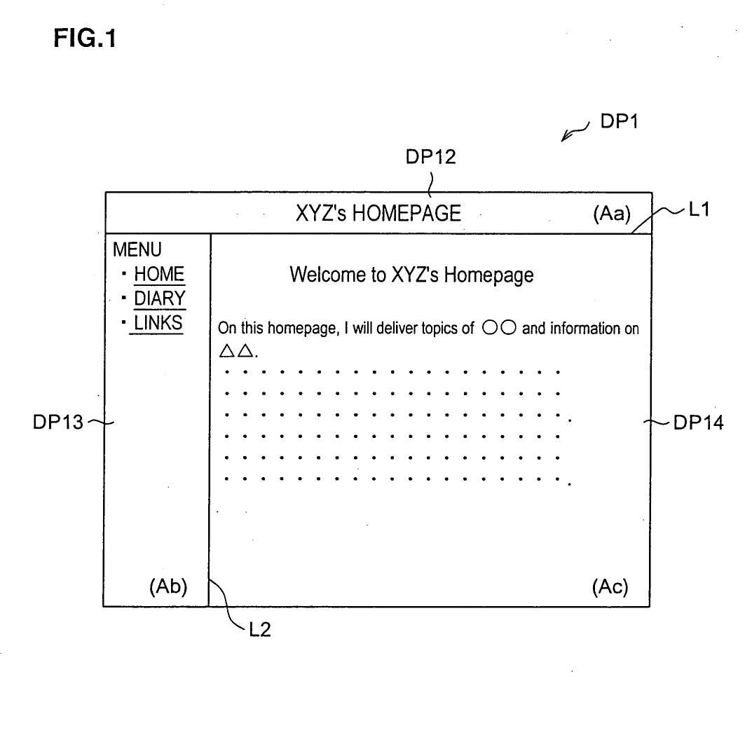

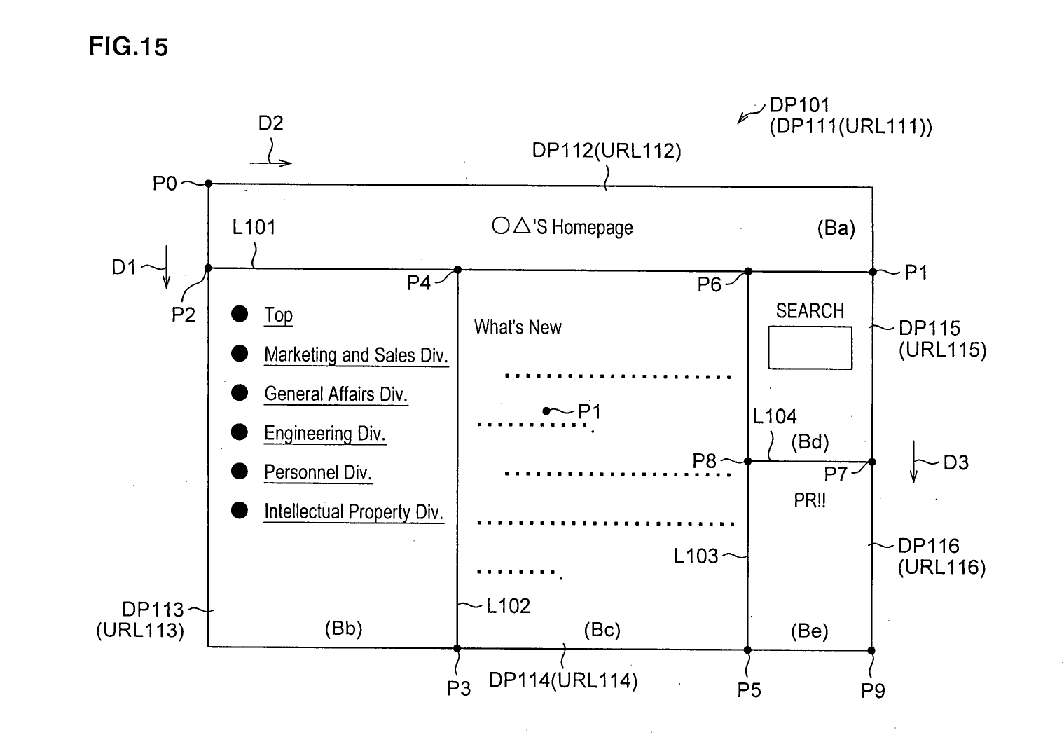

The storage section 32 consists of, for example, a volatile storage device such as a RAM (Random Access Memory) and a nonvolatile storage device such as a hard disk. In this embodiment, the storage section 32 stores HTML files DP11 to DP14 and HTML files DP11 to DP116. As will be described later, the HTML files DP11 to DP14 serve as the constituent elements of a frame page DP1 shown in FIG. 1 whereas the HTML files DP111 to DP116 serve as the constituent elements of a frame page DP101 shown in FIG. 15.

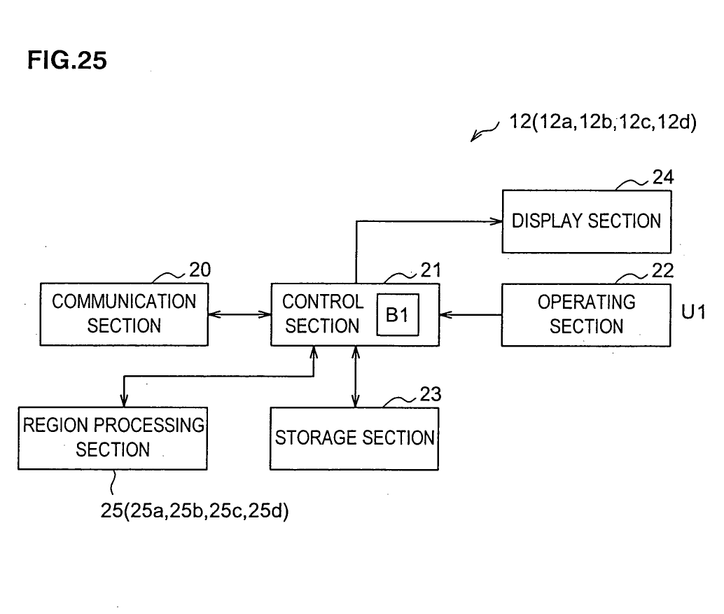

As shown in FIG. 25, the communication terminal 12 includes a communication section 20, a control section 21, an operating section 22, a storage section 23, a display section 24 and a region processing section 25. This communication terminal 12 can be constituted by, for example, a personal computer having a communication function. In this embodiment, the communication terminal 12 also includes a WWW browser B1 which is a program for viewing WWW pages.

The communication section 20 functions to communicate with the other devices including the WWW server 13 through the network

The control section 21 corresponds to the CPU (Central Processing Unit) of the communication terminal 12 in terms of hardware and to the OS (Operating System) and the WWW browser B1 in terms of software.

The operating section 22 is operated by the user U1 of the communication terminal 12 to deliver an instruction to the control section 21. The operating section 22 consists of, for example, a keyboard or a pointing device.

The storage section 23 consists of, for example, a volatile storage device such as a RAM and a nonvolatile storage device such as a hard disk.

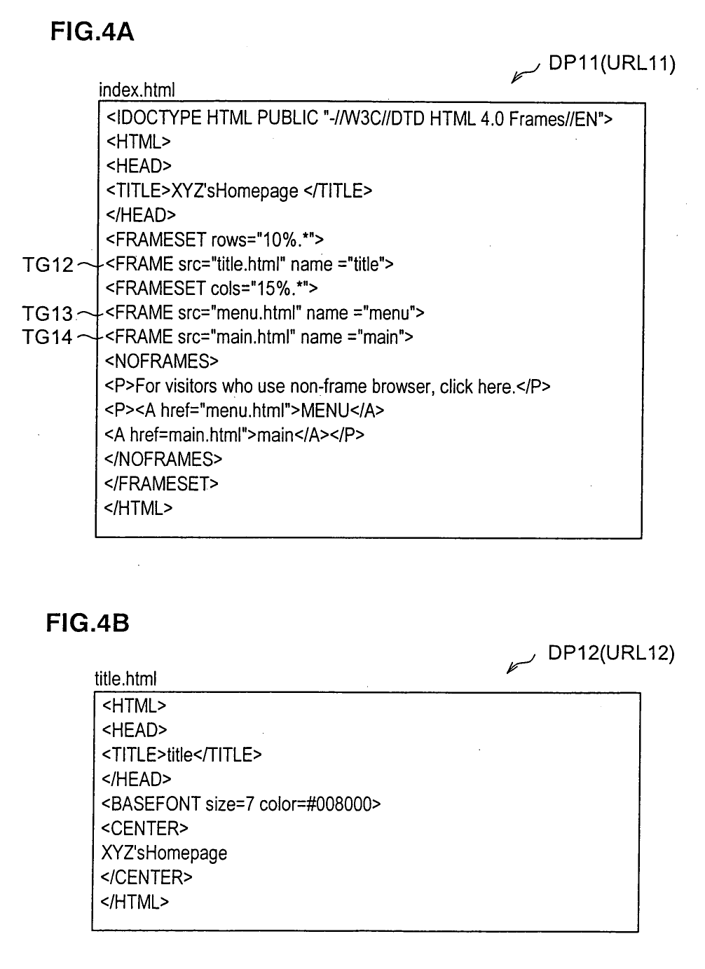

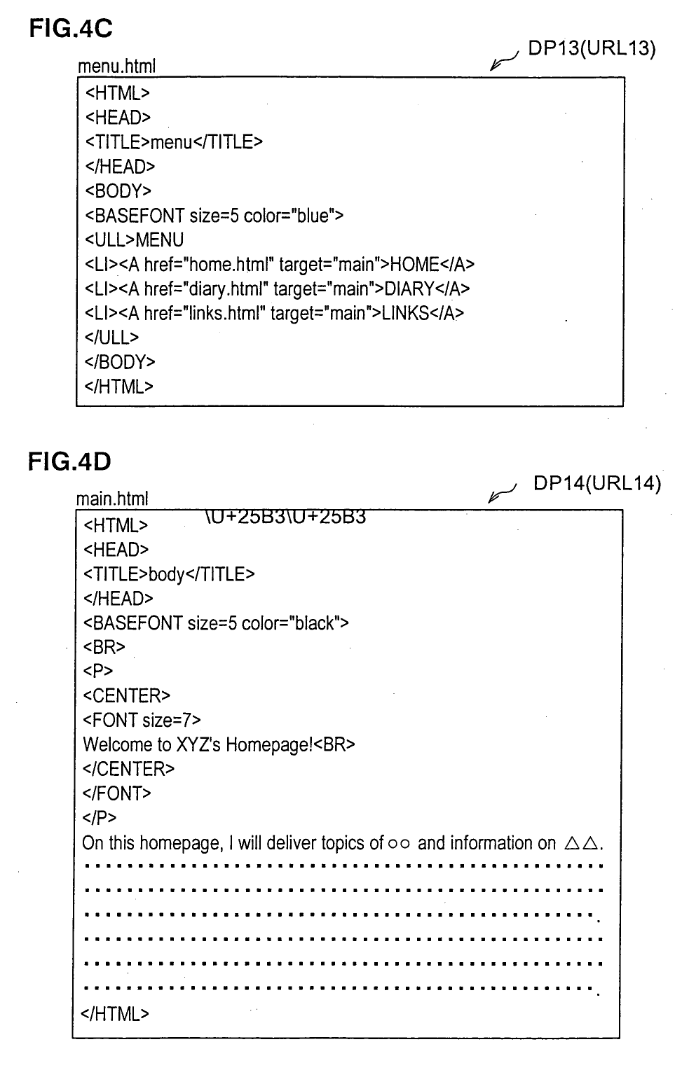

When receiving files which constitute a WWW page (such as the frame definition file DP11 and the HTML file DP12 shown in FIG. 4) from the WWW server 13, the communication terminal 12 temporarily stores the files in a cache region (not shown) secured in the storage section 23.

The files stored in the cache region secured in the storage section 23 are normally managed by the WWW browser B1 and can be freely accessed from the WWW browser B1.

While each of the files stored in the cache region is maintained as much as possible, the storage capacity of the cache region has an upper limit. If the user views a new WWW page and stores new files over this upper limit, the files already stored in the cache region are sequentially deleted in, for example, descending order of storage time. By doing so, a predetermined storage capacity is secured for the cache region.

For example, if the user U1 inputs a URL to the operating section 22 and the files related to a WWW page designated by the URL are stored in the cache region in the storage section 23, then the WWW browser B1 acquires the files not through the network 11 but from the cache region and displays the WWW page on the display section 24. This mechanism enables communication traffic on the network 11, suppressing an increase in load on the WWW server 13 and shortening response time (time since an instruction is issued until the WWW page is displayed) on the user U1 side.

The display section 24 is a section that includes a display screen (e.g., a liquid crystal display). The WWW browser B1 interprets tags described in the files received from the WWW server 13 and constructs a WWW page. The content of this WWW page is displayed on the display section 24 to enable the user U1 to view the content. The frame page DP1 shown in FIG. 1 is one example of the WWW page displayed on the display section 24. In order to display the WWW page consisting of a plurality of frames such as the frame page DP1 on the display section 24, the WWW browser B1 is required to have a frame correspondence function.

In this embodiment, “frame” refers not to a content described in each of the regions (e.g., regions Aa, Ab and Ac of the frame page DP1) of the WWW page (e.g., the frame page DP1 shown in FIG. 1) but to a frame containing the content. In this embodiment, “region” is often used to signify “content” but basically used to signify an equivalent word to “frame”.

Now, the relationship between a frame page and a plurality of HTML files which constitute the frame page will be described.

A WWW page which does not include a frame structure consists of one basic HTML file and, if necessary, one or a plurality of various files (such as image files). A WWW page, such as the frame page DP1, which includes a plurality of frames, by contrast, has many configuration files and a complicated structure.

To be specific, the frame page consists of at least an HTML file (a frame definition file) which defines the overall configuration of the WWW page (frame structure such as the number of frames and the sizes of the respective frames) and a plurality of HTML files arranged in the respective frames as contents. Further, various files (image files, document files and the like) linked to the respective HTML files are appropriately added to the frame page.

In case of the frame page DP1 shown in FIG. 1, for example, even with a simple configuration in which no various files such as image files and document files are present, the frame page DP1 needs four HTML files shown in FIGS. 4A to 4D, i.e., the HTML file (frame definition file) DP11, the HTML file DP12 arranged in the region Aa, the HTML file DP13 arranged in the region Ab and the HTML file DP14 arranged in the region Ac.

In case of the WWW page which does not have a frame structure, a plurality of files are structured only within one HTML file. In case of the frame page, by contrast, files are structured not only within the respective HTML files included in one frame page but also over the plural HTML files.

In FIG. 1, boundary lines (including scrawl bars) L1 and L2 appear among the respective regions Aa, Ab and Ac of the frame page DP1. On an actual frame page, consideration is given to visual effect. Due to this, for example, a uniform base color is often used among different regions or a continuous background pattern without breaks among the regions is often used so as not to display the boundary lines on purpose. For this reason, even if the boundary lines are invisible, it does not follow that the WWW page does not include a plurality of divided regions (does not have a frame structure).

The frame structure defined by the number of divided frames on one screen, the proportions of lengths of the sides of the respective frames (corresponding to the areas of the respective frames in this embodiment), and display/non-display of boundary lines or the like, is described in the frame definition file DP11 show in FIG. 4A.

If the user U1 desires to view the frame page DP1 shown in FIG. 1, the user U1 inputs the URL 11 of the frame definition file DP11 to the WWW browser B1 (FIG. 25) of the communication terminal 12. The communication terminal 12 transmits an HTTP request to request the frame definition file DP1 1 to be returned, to the WWW server 13. The WWW server 13 which receives this HTTP request returns the frame definition file DP11 as an entity body as well as various HTTP headers (including an entity header) as an HTTP response, to the communication terminal 12.

If the communication terminal 12 requests the entity body, i.e., such files as HTML files and image files to be returned, the communication terminal 12 designates a GET method and transmits a GET request as the HTTP request.

When the communication terminal 12 receives the frame definition file DP11, the WWW browser B1 automatically transmits the HTTP request for requesting the HTML files DP12 to DP14 to the WWW server 13 based on the description (URL12 to URL14) in the frame definition file DP11. The WWW server 13 which receives this HTTP request returns the HTML files DP12 to DP14 to communication terminal 12 as the HTTP response.

If these four HTML files, i.e., the frame definition file DP11 and the HTML files DP12 to DP14 are processed and reshaped by the WWW browser B1, the frame page DP1 shown in FIG. 1, for example, is displayed on the display section 24.

As shown in FIG. 4A, the URL12 of the HTML file DP12 corresponds to “title.html” in a line TG12, the URL13 of the HTML file DP13 corresponds to “menu.html” in a line TG13 and the URL14 of the HTML file DP14 corresponds to “main.html” in a line TG14.

If a plurality of HTML files constituting one frame page are put in the same WWW server (WWW server 13 in this embodiment) as that for the frame definition file and put in the same folder (directory), each HTML file can be designated by a local URL (a URL consisting only of a file name in this embodiment) that does not include an FQDN (Fully Qualified Domain Name).

It is also possible to put a plurality of HTML files constituting one frame page in a different WWW server from that for the frame definition file. In that case, an URL including an FQDN, for example, is used for each HTML file. It is noted that the URL11 for specifying the frame definition file DP11 which the user U1 inputs to the WWW browser B1 normally includes an FQDN.

The URL11 for specifying the frame definition file DP11 is input to the WWW browser B1 not only by user U1's operating the operating section 22 but also by such software as an auto-pilot tool (see Patent Document 1). In the latter case, the user U1 can set a date or a time interval for inputting the URL11 to the WWW browser B1 in advance.

In the HTML file DP13 (FIG. 4C) arranged in the menu (region Ab) belonging to the frame page DP1 (FIG. 1), “main” which is the frame name of the region Ac is designated by a target option in a link tag “<A href”. In this case, if the user U1 selects a link button (“HOME”, “Diary” or “Links”) arranged in the menu (region Ab), the content of a linked file (e.g., the HTML file DP14 (FIG. 4D)) set by the link button is loaded to the region Ac.

In case of an ordinary frame page having a menu, by clicking on one of the link buttons arranged in the menu, only the content of the frame (region Ac) designated as a target is changed without changing the contents of the frames (regions Aa and Ab in this embodiment) which are not designated as a target. As a result, it appears to the user U1 that a plurality of layered WWW pages exist only in the region Ac.

Up till now, the relationship between the frame page and a plurality of HTML files constituting the frame page has been described while taking the frame page DP1 (FIG. 1) as an example. The communication terminal 12 (FIG. 25) in this embodiment includes the region processing section (a key region determination section) 25 which functions to determine and extract a key region (an important region) from a plurality of regions (HTML files) constituting the frame page.

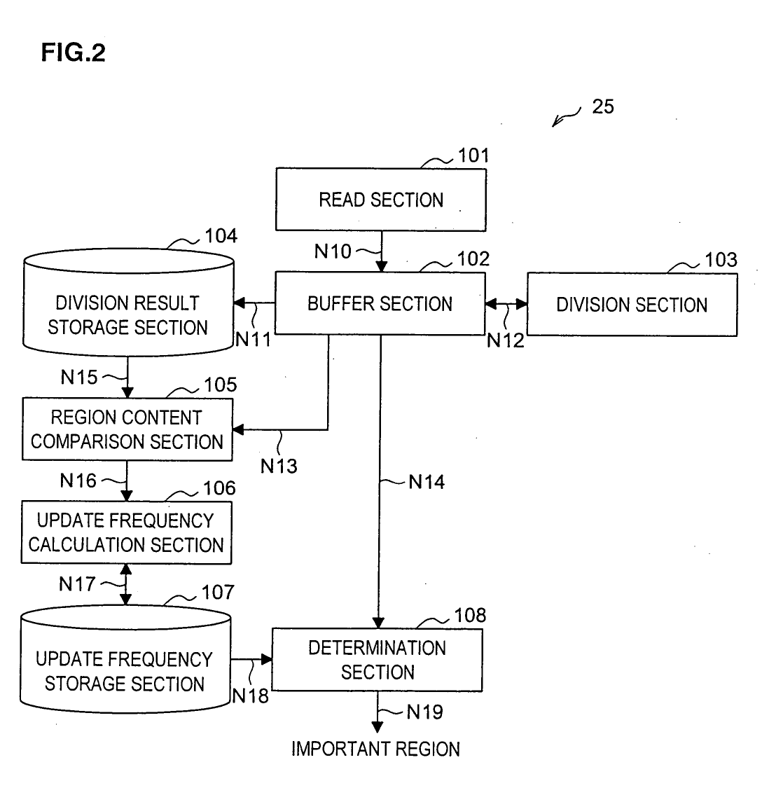

As shown in FIG. 2, this region processing section 25 consists of a read section 101, a buffer section 102, a division section 103 (boundary division section), a division result storage section 104, a region content comparison section 105 (comparison/inspection section), an update frequency calculation section 106, an update frequency storage section 107 and a determination section 108.

In this embodiment, “important region” means one region estimated to be the most important region to the user (user U1) among a plurality of regions on the WWW page. In this embodiment, a region having the highest update frequency is basically set as the important region. In case of the frame page DP1 shown in FIG. 1, for example, one region estimated to be the most important region to the user U1 (to have the highest update frequency) among the regions Aa, Ab and Ac becomes the important region. Further, the important region may be determined and extracted for a plurality of frame pages which are equal except that only the contents of the target frame (e.g., the region Ac) are changed so as to correspond to a typical method for using a frame page having a menu (which is the region Ab in case of the frame page DP1).

The function of the region processing section 25 is realized by a personal computer having a communication function or the other information processing apparatus. In this embodiment, the region processing section 25 is arranged on the communication terminal (client) 12 side. Alternatively, the region processing section 25 can be arranged on the WWW server 13 side.

Further, in this embodiment, the region processing section 25 is provided separately from the WWW browser B1. Alternatively, the region processing section 25 can be incorporated into the WWW browser B1 as a part of the function thereof.

For example, if the URL11 is input to the WWW browser B1 regularly by the auto-pilot tool or manually, irregularly by the user U1, the WWW browser B1 receives the frame definition file DP11 specified by the URL11 from WWW server 13 or the cache region in the storage section 23. The read section 101 included in the region processing section 25 functions to give information N10 on the frame definition file DP11 received by the WWW browser B1 to the buffer section 102.

In order that the read section 101 reads the frame definition file DP11 through the Internet 11, this read section 101 preferably functions as a part of the WWW browser B1, cooperate with the WWW browser B1 or functions as an HTTP client independent of the WWW browser B1.

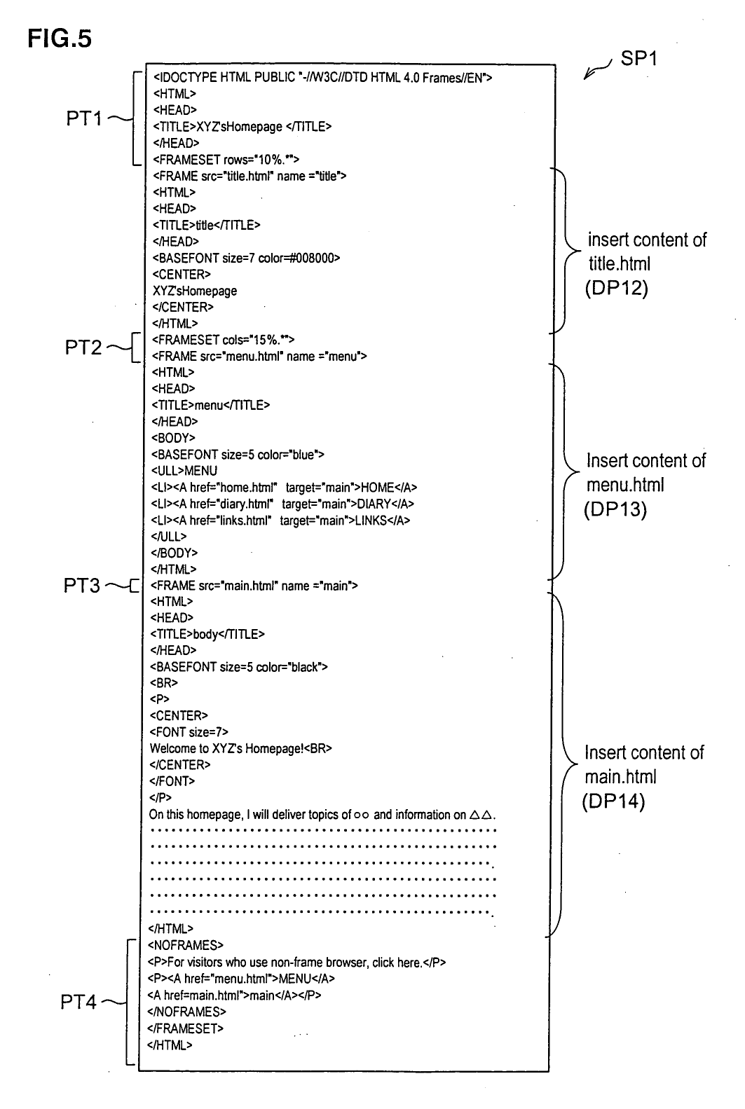

FIG. 5 shows one example of the file read by the read section 101. This composite file SP1 includes the contents of the HTML files DP11 to DP14 shown in FIGS. 4A to 4D, respectively. It is noted, however, that the content of the frame definition file DP11 is arranged after being divided to four parts PT1 to PT4 in the composite file SP1.

The WWW server 13 may manage that the HTML files DP11 to DP14 are files corresponding to one frame page. With this configuration, when the WWW server 13 receives an HTTP request related to the frame definition file DP11, the WWW server 13 can generate one composite file SP1 based on the four HTML files DP11 to DP14 and transmit the generated composite file SP1 to the communication terminal 12 as the entity body of one HTTP response. In this case, however, it is necessary to consider the magnitude of load imposed on the WWW server 13, the compatibility of the file SP1 to the cash system or the like.

Normally, therefore, a processing for generating the composite file SP1 is executed by the client (communication terminal 12). In this case, for the user to view the frame page DP1 shown in FIG. 1, a total of four HTTP requests are transmitted from the communication terminal 12 to the WWW server 13 and corresponding four HTTP responses are returned from the WWW server 13 to the communication terminal 12. Among the four HTTP responses, the entity bodies of the three HTTP responses correspond to the HTML files DP12 to DP14.

Normally, the composite file SP1 is not obtained until a processing (reshaping processing) is performed after the communication terminal 12 receives all the HTML files DP11 to DP14.

The buffer section 102 included in the region processing section 25 temporarily stores the contents read by the read section 101 and the processing result of the division section 103. Storage resources for realizing the storage functions such as the division result storage section 104 and the update frequency storage section 107 to be described later as well as this buffer section 102 may be separately secured from the storage section 23 (FIG. 25) included in the communication terminal 12 or secured in the storage section 23.

The division section 103 functions to analyze the WWW page read by the buffer section 102 and thereby divide the storage content of the buffer section 102 into a plurality of regions based on a pre-designated document structure. It is noted that the respective regions (e.g., regions Aa, Ab and Ac) constituting the frame page correspond to the different HTML files (HTML files DP12, DP13 and DP14), respectively. Therefore, if the WWW page read by the buffer section 102 is a frame page, an ordinary file management system which can conducts file management can be included in the communication terminal 12 and the division function of the division section 103 can be omitted. If the OS is responsible for the file management, the division section 103 may sequentially repeat a processing for requesting this OS to transmit the HTML files stored in the buffer section 102 and receiving the HTML files in response to the request, whereby it is possible to attain the same result as that when the frame page is divided into a plurality of regions.

However, if the division section 103 cannot receive the HTML files DP11 to DP14 before the reshaping processing and cannot receive the composite file SP1 after the reshaping processing owing to the interface between the WWW browser B1 and the region processing section 25 (read section 101), the division section 103 performs a division processing for dividing the frame page.

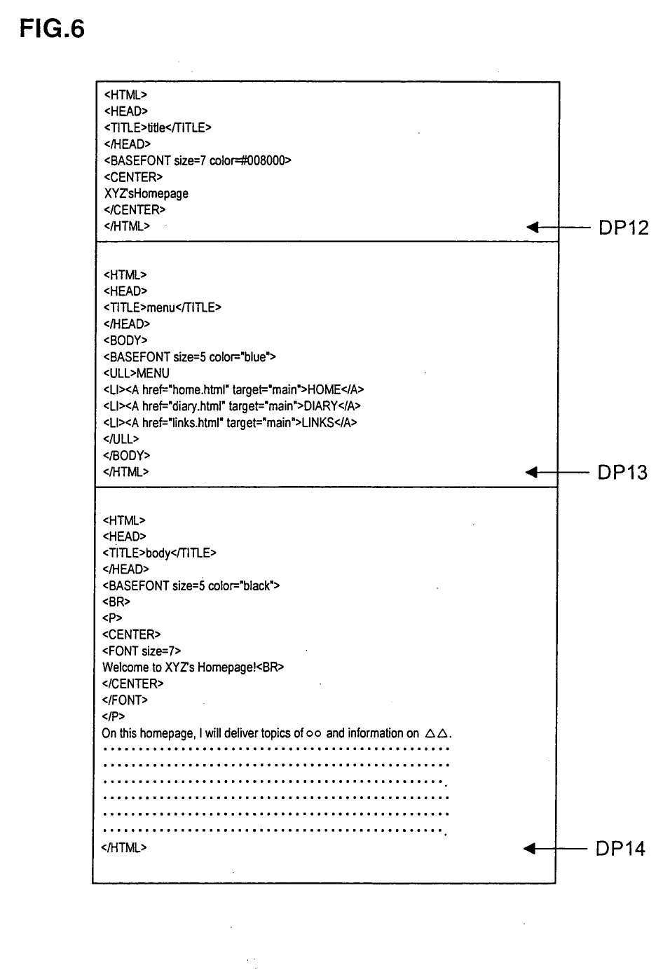

In this embodiment, “division” means, for example, a processing for excluding the parts PT1 to PT4 from the composite file SP1 shown in FIG. 5 and obtaining the three HTML files DP12, DP13 and DP14 shown in FIG. 6.

The files (e.g., DP12 to DP14) divided by the division section 103 (or received from the OS) are supplied to the division result storage section 104 via the buffer section 102.

The division result storage section 104 is a functional section which stores a file N11 supplied from the buffer section 102. The file N11 supplied from the buffer section 102 to the division result storage section 104 is compared with a file N12 stored in the buffer section 102 next to the file N11. It is, therefore, preferable that the division result storage section 104 sores the file N11 in such a way that the correspondence between the file N11 and the file N12 stored next in the buffer section 102 is clear. For example, an HTML file which is currently loaded to the region Ac made correspond to the HTML file DP14 which is loaded next to the region Ac so as to discriminate from the other HTML file (e.g., the HTML file DP13 loaded to the region Ab).:

To make the files correspond to each other, the file names (e.g., URL12 to URL14) of the respective HTML files can be used. It is also preferable to allocate inherent file identifiers (region numbers) to the respective HTML files in the system.

The region content comparison section 105 compares the content of each file N11 stored in the division result storage section 104 with that of each file stored in the buffer section 102 for each file (i.e., each region) and detects whether each region is updated. Each file stored in the buffer section 102 is the file which is currently loaded to each of the regions constituting the frame page. Each file stored in the division result storage section 104 is the file which is loaded to each region just before the file stored in the buffer section 102. The region content comparison section 105 outputs update/non-update information N16 as a detection result. In this embodiment, “update” means that a part of or all of the content of a file is subjected to addition, deletion or change.

The update frequency calculation section 106 calculates a present update frequency S based on a predetermined formula from the content of the update/non-update information N16 and a previous update frequency and outputs update frequency information N17 according to the calculated update frequency S. The calculation of the update frequency S is conducted for each file (for each region). The update frequency S may be higher as the update frequency of the file increases. Conversely, the update frequency S may be lower as the update frequency of the file increases. In this embodiment, the update frequency S which is lower as the update frequency of the file increases is used.

Further, to calculate the update frequency S, various forms of formulas are available. In this embodiment, the following formula (F1) based on exponential average is used.

S=S₀α+P(1−α) (F1)

In the formula F1, S₀ denotes a previous update frequency. Factor α takes a value in a range of 0<α<1; however, it is assumed that α=0.8. P denotes a point and takes either “100” or “0”. As will be described later, if update is performed, the point P is set at “0”. If update is not performed, the point P is set at “100”. Accordingly, the value of the update frequency S is lower as update is performed once (S₀ is a positive value).

An HTTP response to a GET request is included not only in the entity body (file) but also in various HTTP headers. Due to this, information contained in the HTTP header can be used in the processing of the update frequency calculation section 106.

For example, update date information or effective term information contained in the entity header which is one of the HTTP headers may be used to calculate the update frequency S.

The update date information is information which shows a date at which the file is updated on the WWW server 13 side.

The term-of-validity information is information for setting a term in which the file is stored in the cache region of the storage section 23, a cache server on the network 11 or the like. Using this term-of-validity information, the content of the file can be maintained to the latest content. The term-of-validity information is normally set by a file creator (WWW page creator) in accordance with the specification of the WWW server 13. In the communication terminal 12 (or the cache server present between the communication terminal 12 and the WWW server 13), even if the storage capacity thereof is enough, the file the term of validity of which elapsed is deleted from the cache region and the original file of the file is acquired from the WWW server (WWW server 13 in this embodiment).

If the term of validity is set short, the probability increases that a file having the latest content can be provided to the user (user U1 in this embodiment) even if update is performed with high frequency. However, if the term of validity is set too short, the advantage of providing the cache region is decreased and the load of the WWW server 13 increases. Therefore, the term of validity is normally set as long as possible.

The term-of-validity information set by the creator of the WWW page serves as update plan information which indicates with which frequency the WWW page creator updates each file. As for the WWW page, such as an electronic bulletin board (CGI bulletin board) or a schedule management table, that a third party updates each file, the term-of-validity information indicates the frequency the WWW page creator estimates to update each file by the third party. In case of the electronic bulletin board, the update frequency is high and irregular, so that the cache function is often left unused.

In this way, the term-of-validity information on each file constituting the WWW page is allocated by the WWW page creator familiar with the update plan and the use of each file. Therefore, the utility value and reliability of the term-of-validity information as the update plan information are high.

To obtain the update frequency S of each file using the term-of-validity information allocated to the file, the update frequency calculation section 106 can use several algorithms. For example, in calculating the update frequency S, it is further preferable to add a weighting processing so that the update frequency S becomes higher as the term of validity indicated by the term-of-validity information is shorter.

The update frequency storage section 107 receives the update frequency information N 17 according to the update frequency S from the update frequency calculation section 106 and stores the update frequency information N 17 for each region.

The determination 108 determines that a region the content of which is changed most frequently is an important region based on the update frequency information N 17 stored in the update frequency storage section 107. The determination section 108 then fetches the content of the important region from the buffer section 102 and outputs the fetched content as important region information N 19. The important region information N19 is output to, for example, the WWW browser B1. If WWW browser B1 is required to display the important region on the display screen24, the frame definition file DP11 and the important region (important region information N19) together are given in WWW browser B1.

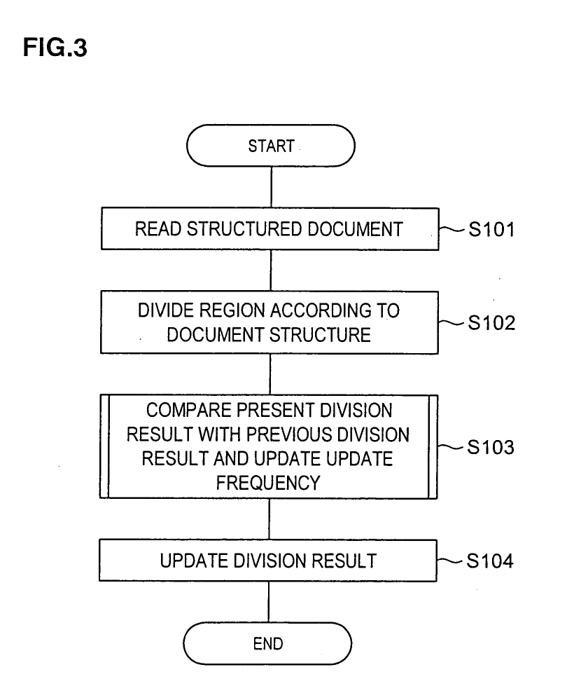

The operation of the communication system 10 constituted as stated above in this embodiment, particularly, the operation of the region processing section 25 which belongs to the communication terminal 12 will now be described with reference to the flow charts of FIGS. 3, 7 and 8.

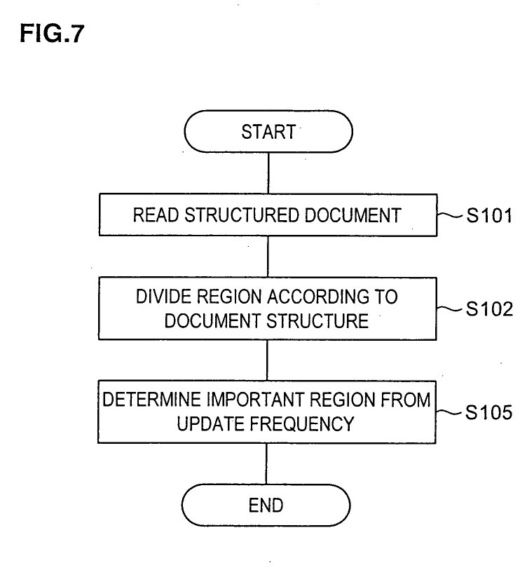

FIG. 3 is a flow chart showing the operation of the region processing section 25 which calculates the update frequency of each frame (region) constituting the frame page DP1 and updates the update frequency information N17. This operation (file update detection processing) consists of steps S101 to S104. FIG. 7 is a flow chart showing the operation of the region processing section 25 which determines an important region and outputs the important region information N19 based on the update frequency information N17. This operation (important region determination processing) consists of steps S101, S102 and S105.

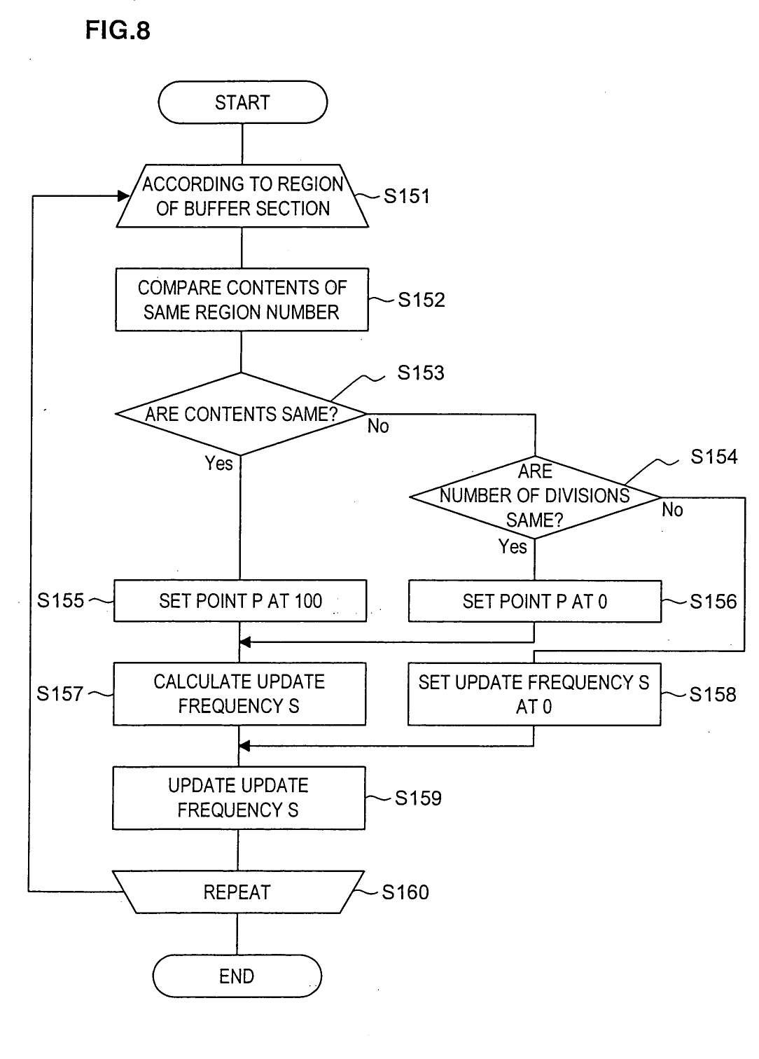

FIG. 8 shows the detail of the step S103 of the file update detection processing shown in FIG. 3, i.e., a flow chart showing the calculation of the update frequency S and processing steps related to the calculation of the update frequency S performed by the region processing section 25. This processing consists of steps S151 to S160.

First, when the URL11 is input to the WWW browser B1 by the user U1's operating the operating section 22 or the function of the auto-pilot tool or the like, the WWW browser B1 transmits an HTTP request (a GET request) corresponding to the URL11 to the WWW server 13.

If the region processing section 25 has a function as an HTTP client separately from the WWW browser B1, the URL11 is input not to the WWW browser B1 but to the region processing section 25.

If receiving this HTTP request transmitted from the communication terminal 12 via the internet 11, the WWW server 13 (server OS) fetches the frame definition file DP11 designated by the URL11 from the storage section 32. The WWW server 13 returns an HTTP request including the frame definition file DP11 as an entity body to the communication terminal 12.

If the communication terminal 12 receives the frame definition file DP11, the WWW browser B1 automatically, sequentially transmits respective HTTP requests to the WWW server 13 based on the description (URL12 to URL14) given in the frame definition file DP11. The WWW server 13 transmits the HTML files DP12 to DP14 which constitute the frame page DP1 as entity bodies of the HTTP responses to the respective HTTP requests, to the communication terminal 12. The HTML files DP12 to DP14 are read by the region processing section 25 which belongs to the communication terminal 12.

If the composite file SP1 is generated on the WWW server 13 side, an HTTP response including this composite file SP1 as an entity body is returned from the WWW server 13 to the communication terminal 12.

As shown in FIG. 3, the read section 101 included in the region processing section 25 of the communication terminal 12 reads the frame definition file DP11 or the composite file SP1 solely or in cooperation with the WWW browser B1, and stores the read file in the buffer section 102 (in the step S101). If the read section 101 solely reads the file, the entity body of the HTTP response is read by the read section 101 as it is. If the read section 101 reads the file in cooperation with the WWW browser B1, the result of the processing of the WWW browser B1 side is read by the read section 101.

In either case, the file read by the read section 101 may be the frame definition file DP11 shown in FIG. 4A or the composite file SP1 shown in FIG. 5.

If the file read by the read section 101 is the composite file SP1, this composite file SP1 is divided by the division section 103 (in the step S102). If the file read by the read section 101 is the frame definition file DP11, it is unnecessary to perform a division processing.

However, if the frame definition file DP11 is read by the read section 101, the communication terminal 12 needs to sequentially transmit HTTP requests so as to acquire the three HTML files DP12 to DP14.

Whether the composite file SP1 is read by the read section 101 or not, the file names of the HTML files DP12 to DP14 can be used to discriminate the respective HTML files DP12 to DP14 and make the files correspond to one another. Alternatively, region-based numbers (region numbers) may be allocated to the respective HTML files DP12 to DP14 so as to discriminate the respective HTML files DP12 to DP14 using the region numbers.

In this embodiment, region numbers 1, 2 and 3 are allocated to the HTML files DP12, DP13 and DP14, respectively. As a result, the HTML file DP12 is allocated to a region 1 in the frame page DP1, the HTML file DP13 is allocated to a region 2 in the frame page DP1 and the HTML file DP14 is allocated to a region 3 in the frame page DP1.

In the step S103, the region content comparison section 105 compares the files currently read by the read section 101 (or divided files at need) with the files previously read by the read section 101, and detects whether there is a difference between the current and previous files, i.e., whether file update has been performed. Based on the detection result, the update frequency calculation section 106 calculates the update frequency S. The update frequency storage section 107 stores the calculated update frequency S.

The contents of the currently read (or divided) files DP12 to DP14 are stored in the division result storage section 104 in place of the contents of the previously read files. The region processing section 25 prepares for the reading of the next new files (in the step S104).

The file update detection processing consisting of the steps S101 to S104 is repeated a plurality of number of times at need. If the file update is detected by a few (e.g., once) file update detection processings, there is no avoiding the probability that the files are accidentally updated at the timing. In order to eliminate such contingency, discover an actual file update frequency and obtain a required effect, it is preferable to detect the file update for a long period of time and repeat the file update detection processing as much as possible.

By using the term-of-validity information (update plan information) of each file, the contingency may possibly be eliminated even if the repetition number of times of the file update detection processing is relatively small.

In this embodiment, if the repetition number of times of the file update detection processing is small and a detection period for detecting whether or not file update has been performed is short, the last update file is highly likely to be selected as an important region. In many cases, the last update region coincides with the most important region to the user U1. According to this embodiment, therefore, even if the repetition number of times of the file update detection processing is small, the important region can be appropriately selected.

The detail of the step S103 of updating the file update frequency will next be described with reference to FIG. 8. In this embodiment, the HTML files DP12 to DP14 are discriminated by the region numbers allocated thereto, respectively.

Steps S152 to S159 shown in FIG. 8 are repeated for each file (each region) based on the region numbers respectively allocated to the files DP12 to DP14 stored in the buffer section 102.

Among these steps, in the step S152, the files previously read by the read section 101 (or previously divided by the division section 103) are compared with the files currently read by the read section 101 (or presently divided by the division section 103), that is, the files stored in the division result storage section 104 are compared with the files stored in the buffer section 102 while making them correspond to one another based on the respective region numbers (in the step S153).

If the comparison result indicates that the contents of the files are same, i.e., the files have not been updated, the processing branches to “Yes” side in the step S153. Using the above-stated formula (F1), the point P is set at “100” (in the step S155) and the update frequency S is calculated (in the step S157). The previous update frequency S₀ stored in the update frequency storage section 107 is replaced by the update frequency S thus calculated.

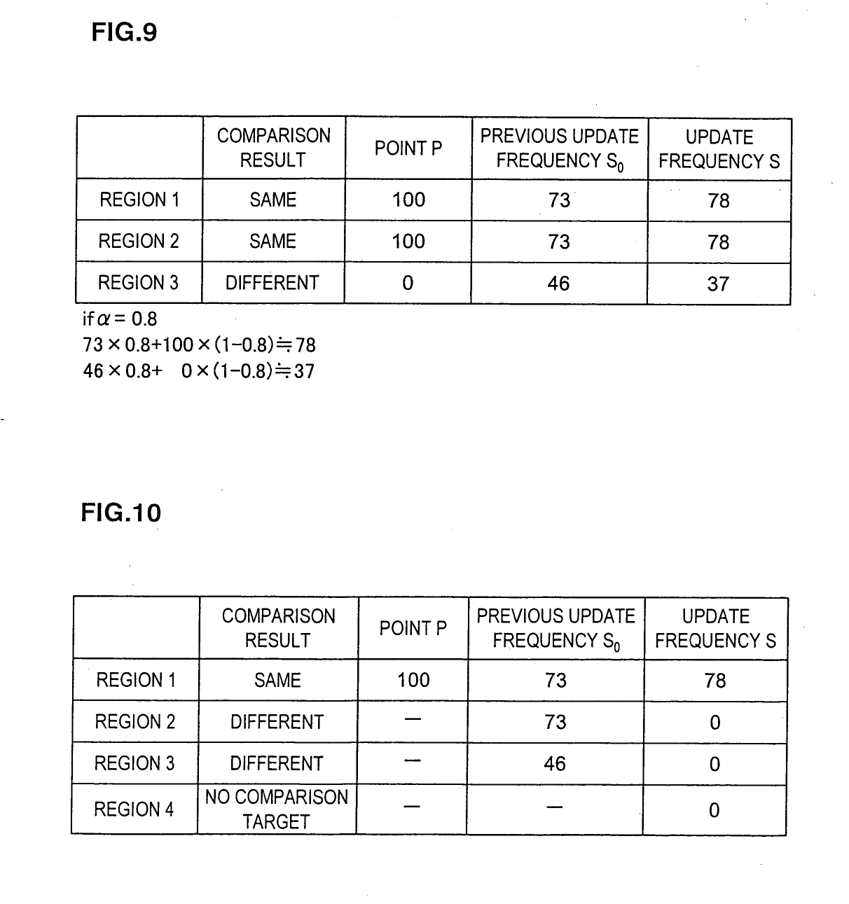

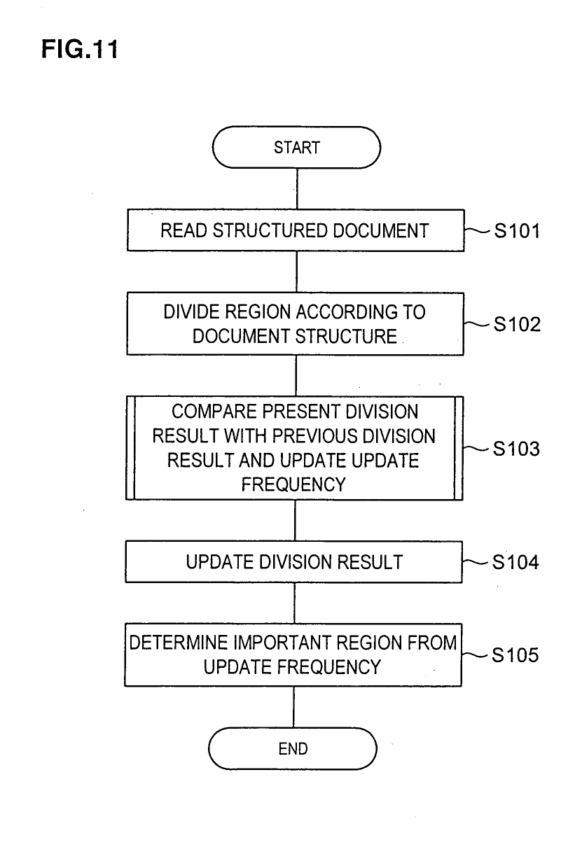

To be specific, if the content of the region 1 of the frame page DP1 is the same as the previous content and the previous update frequency S₀ of the region 1 is 73 (S₀=73), the current update frequency S of the region 1 is “78” (≈73×0.8+10×(1−0.8)) according to the formula (F1) as shown in FIG. 9.

Further, if the content of the region 2 of the frame page DP1 is the same as the previous content and the previous update frequency S₀ of the region 2 is 73 (S₀=73), the current update frequency S of the region 2 is also “78”.

On the other hand, if the comparison result of the step S153 indicates that the contents of the files are not the same, i.e., the files have been updated, the processing branches to “No” side in the step S153. Next, it is checked whether or not the number of divisions change (in the step S154). “Number of divisions” means herein the number of files other than the frame definition file DP11 among the files constituting the frame page DP1. In this step S154, therefore, it is determined whether the frame structure (particularly the number of frames) changes.

Whether the frame structure changes can be grasped by analyzing the description content of the frame definition file DP11 without the need to check the number of files constituting the frame page DP1. For example, by counting character strings “<FRAME src” in the frame definition file DP11, it is possible to calculated the number of frames of the frame definition file DP11.

As already stated, the concept of the frame structure involves not only the number of frames but also the proportions of lengths of the sides of the respective frames. However, in the step S154, only the number of frames is determined. Due to this, even if the description of the frame definition file DP11 change and the length proportions of the sides of the respective frames change, the processing branches to the “Yes” side in the step S154 as long as the number of frames has no change.

Conversely, if the description of the frame definition file DP11 changes even without changing the number of frames, the processing may branch to the “No” side in the step S154.

Furthermore, if one of the URL12 to URL14 described in line TG12 to TG14, respectively, is updated in the frame definition file DP11 shown in FIG. 4A, this follows that the contents of the respective HTML files DP12 to DP14 are not updated but that the HTML files arranged in the respective frames are replaced by the other HTML files. In this case, it is preferable that the processing branches to the “Yes” side in the step S154.

If a new region 4 (a region allocated a region number 4) is arranged on the frame page DP1 on which only the three regions 1 to 3 exist as shown in FIG. 10, the processing branches to the “No” side in the step S154. The update frequency S of the region 4 is set at “0” (in the step S158) and the processing goes to the step S159. The reason that the update frequency S of the region 4 is set at an initial value “0” is that there is no comparison target for the newly added region 4.

If the comparison result of the step S153 indicates that the contents of the files do not coincide and that the number of divided regions of the frame page DP1 has no change, the processing branches to “Yes” side in the step S154. The point P is set at “0” in the formula (F1) for each region (in the step S156) and the update frequency S is calculated (in the step S157).

For example, the processing regarding to the region 3 branches to “Yes” side in the step S154, the previous update frequency S₀ of the region 3 is 46 (S₀=46), the current update frequency S of the region 3 is “37” (≈46×0.8+0(1−0.8)) according to the formula (F1) as shown in FIG. 9.

In this way, the update of the update frequency S of each of the regions 1 to 3 stored in the update frequency storage section 107 is performed once or repeatedly for a plurality of number of times. Based on the update frequency S thus calculated, the important region is determined from the plural regions constituting the frame page DP1 This important region determination processing will be described with reference to FIG. 7.

The important region determination processing shown in FIG. 7 consists of almost the same steps S101 and S102 as those of the file update detection processing shown in FIG. 3 and also consists of the step S105 of determining the important region from the update frequency S.

In this step S105, the determination section 108 determines the important region from the plural regions constituting the frame page DP1 based on the update frequencies S stored at that moment in the update frequency storage section 107. For example, if the update frequency S of the HTML file DP14 corresponding to the region 3 has the lowest value, the region 3 corresponding to this HTML file DP14 is selected as the important region and output as the important region information N19. In this embodiment, the region having the low update frequency S is updated at high frequency.

If the update frequencies S of a plurality of regions are the same, one of the regions may be specified as an important region using the terms-of-validity allocated to the HTML files corresponding to the respective regions. Alternatively, a plurality of regions may be output as important regions and the determination of the important region may be left to the discretion of the user U1. Further, one region is output as the important region and the user U1 is notified that the other regions having the same update frequency S as that of the important region exist separately.

If the auto-pilot tool is used, for example, the URL's of a plurality of frame definition files are set to this auto-pilot tool and access dates and access intervals for the respective URL's are set thereto, whereby it is possible to execute the same processings to the multiple frame pages in parallel. As a result, only the important regions are selectively extracted from the multiple frame pages. The user U1 can efficiently recognize the outlines of many frame pages with less labor and shorter time. However, if the important regions are extracted from a plurality of frame pages in parallel, the division result storage section 104 and the update frequency storage section 107 are required to store various pieces of information while putting them in order for the respective frame pages.

As described so far, according to the first embodiment, the important region is automatically determined from a plurality of regions which constitute the frame page. Due to this, in notifying the user of the update of a designated web page, for example, it is possible to facilitate establishing a service system for excluding the update of the regions other than the important region from a notification target. It is also possible to facilitate establishing a search system for excluding the regions other than the important region from a search target or providing a document scrap service for setting only the important region as a summary target.

Furthermore, according to this embodiment, it is unnecessary for the user to manually designate the start point and end point of extracted data to the system in advance. It is thereby possible to lessen operation burden on the user.

According to this embodiment, operation burden on the user for outputting the selected important region from the frame page is lessened. This is particularly effective when only the important regions are selected from among multiple frame pages and outputting the important regions.

In the information processing in this embodiment, there is no need to use a natural language. It is, therefore, possible to determine the important region without depending on the description language.

Moreover, according to the present invention, only the document structure designated in advance is checked, so that the processing quantity of information for analyzing a frame page can be considerably reduced.

### Second Embodiment

In the first embodiment, it is detected whether file update has been performed by storing and comparing the contents of the HTML files themselves. In the second embodiment, by contrast, a checksum indicating the content of each file is employed in various information processings.

A communication terminal 12a in this embodiment shown in differs in configuration from the communication terminal 12 in the first embodiment shown in FIG. 25 in that the region processing section 25 is replaced by a region processing section 25a.

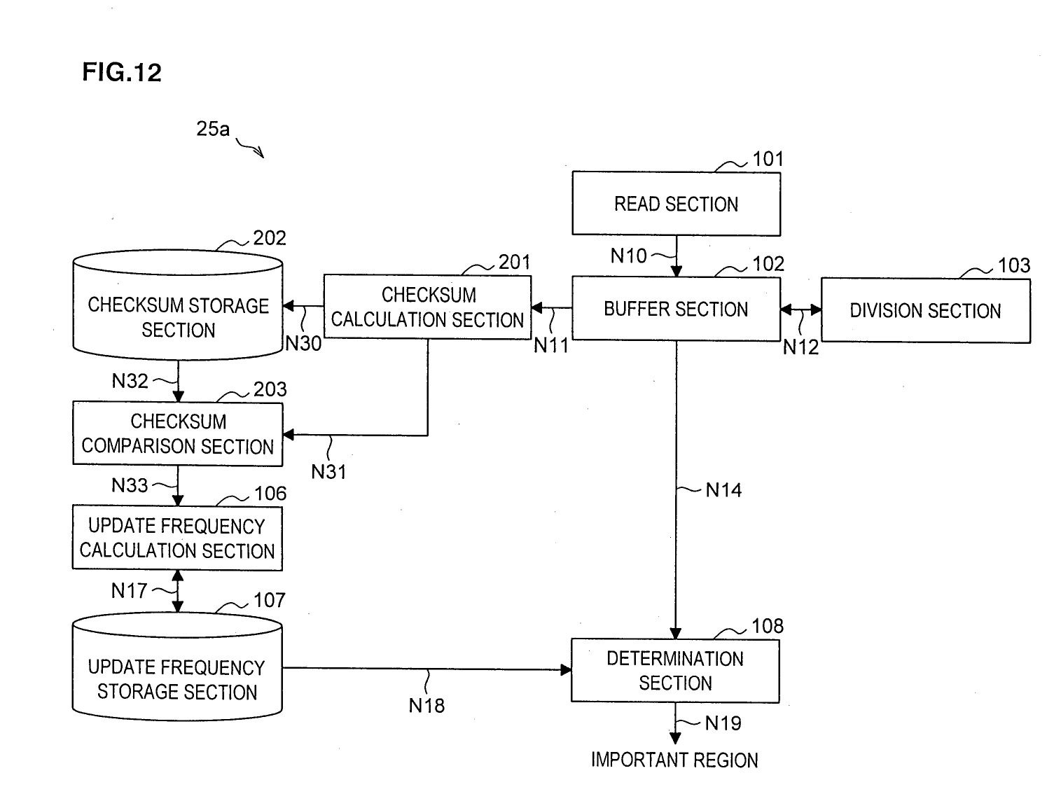

The region processing section 25a in this embodiment shown in FIG. 12 differs in configuration from the region processing section 25 shown in FIG. 2 in that the division result storage section 104 is replaced by a checksum storage section 202, the region content comparison section 105 is replaced by a checksum comparison section 203 and a checksum calculation section (conversion section) 201 is additionally provided. Namely, the region processing section 25a consists of the read section 101, the buffer section 102, the division section 103, the update frequency calculation section 106, the update frequency storage section 107, the determination section 108, the checksum calculation section 201, the checksum storage section 202 and the checksum comparison section 203.

The checksum calculation section 201 calculates a checksum based on the contents of the respective files read by the read section 101 and stored in the buffer section 102 and outputs a calculation result as checksum information N30 and N31.

The checksum storage section 202 stores the checksum information N30 output from the checksum calculation section 201. This is the functional difference of the checksum storage section 202 from the division result storage section 104 (FIG. 2) which stores the contents of files read by the read section 101 (or the division results of the division section 103). If the size of a certain file is compared with the size of the checksum calculated from the file, the size of the checksum is normally smaller. Therefore, a storage capacity necessary for the checksum storage section 202 is smaller than that of the division result storage section 104.

The checksum comparison section 203 compares the checksum of the files previously read by the read section 101 (checksum information N32 output from the checksum storage section 202) with the checksum of the files currently read by the read section 101 (the checksum information N31 output from the checksum calculation section 201) to thereby detect whether the respective files have been updated, and outputs update/non-update information N33 according to the detection result.

If it is detected whether the respective files have been updated based on the checksums, there is a probability that the checksums are the same although the files have been actually updated and it is determined that no file update has been performed. This erroneous detection can be avoided by setting the size of the checksum (the number of bits) large.

The operation of the region processing section 25a constituted as stated above in this embodiment will be described with reference to FIGS. 7, 13 and 14.

As shown in FIG. 7, the important region determination processing is common to the region processing section 25a and the region processing section 25 in the first embodiment.

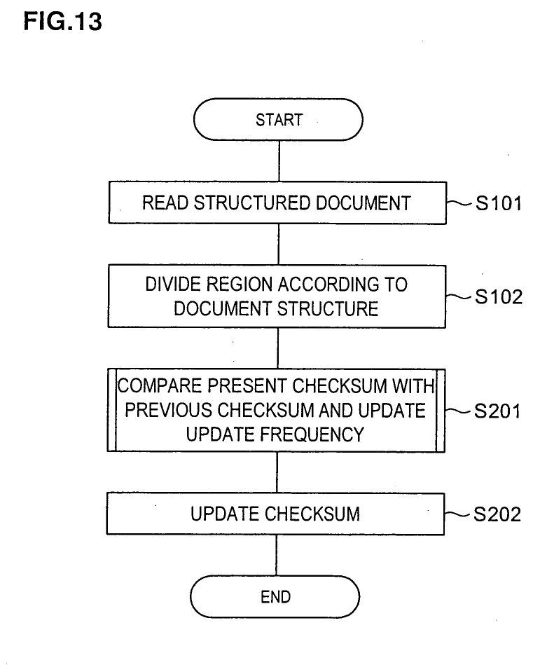

Further, the file update detection processing of the region processing section 25a shown in FIG. 13 differs from that of the region processing section 25 in the first embodiment shown in FIG. 3 in that the step S103 is changed to a step S201 and the step S104 is changed to a step S202.

In the step S103, it is detected whether the respective files have been updated based on the contents of the files. In the step S201, it is detected whether the respective files have been updated based on the checksum of the respective files.

In the step S202 next to the step S201, the checksum of the currently read files is stored in the checksum storage section 202 in preparation for the reading of the next new files.

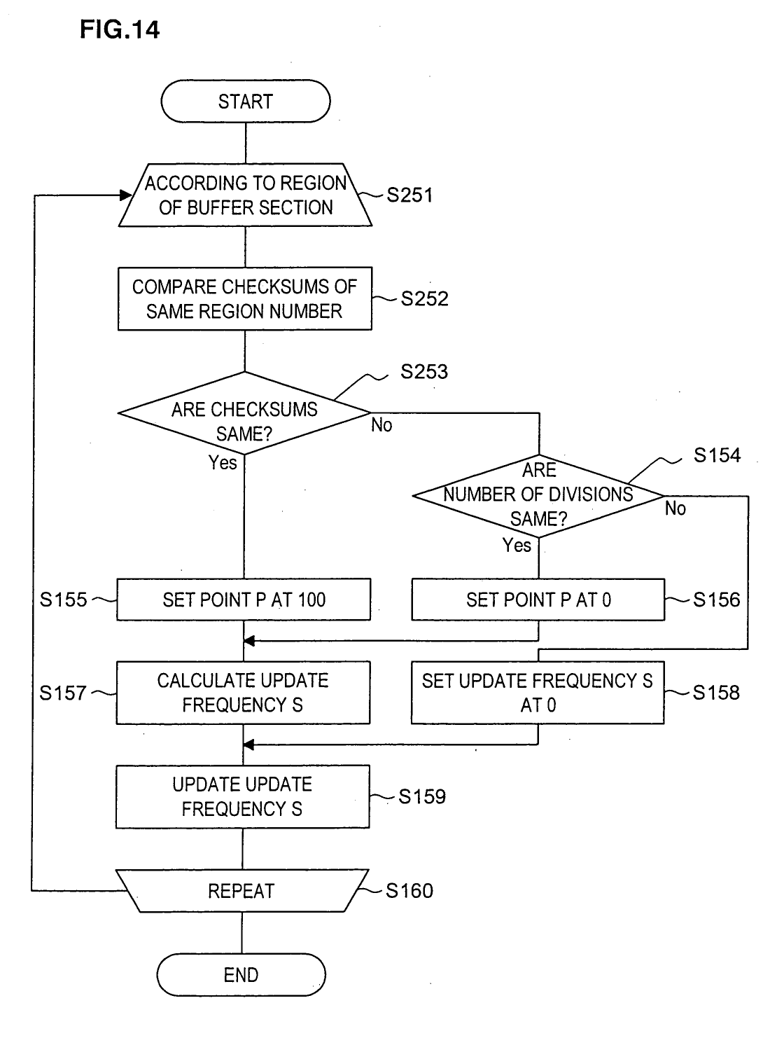

FIG. 14 shows the detail of the step S201 of the file update detection processing shown in FIG. 13, i.e., a flow chart showing the calculation of the update frequency S and processing steps related to the calculation of the update frequency S performed by the region processing section 25a.

The file update detection processing of the region processing section 25a in this embodiment shown in FIG. 14 differs from that of the region processing section 25 in the first embodiment shown in FIG. 8 only in that the steps S151 to S153 are changed to steps S251 to S253.

In the steps S151 to S153 in the first embodiment, it is determined whether the files have been updated based on the contents of the respective files. In the steps S251 to S253 in this embodiment, by contrast, it is determined whether the files have been updated based on the checksum of the files instead of the contents of the file.

As can be seen, the second embodiment can attain the equivalent advantages to those of the first embodiment.

Further, according to this embodiment, a storage means having a small storage capacity can be used as the checksum storage section 202. It is thereby possible to save the storage resources of the entire system.

Furthermore, according to this embodiment, the checksum of the respective files is used so as to detect whether the files have been updated. Since the size of the checksum is small, it is possible to read and write the checksum from and to such a storage resource as a memory in short time. As a result, it is possible to shorten processing time required to determine and extract the important region.

### Third Embodiment

A communication terminal 12b in the third embodiment differs in configuration from the communication terminal 12 in the first embodiment shown in FIG. 25 in that the region processing section 25 is replaced by a region processing section 25b. In addition, the communication terminal 12b in this embodiment, similarly to the communication terminal 12 in the first embodiment, functions as a part of the communication system 10 shown in FIG. 24. The detail of the region processing section 25b will be described later.

In each of the first and second embodiments, the communication terminal has been described while referring to the frame page DP1 shown in FIG. 1. This frame page DP1 includes three frames (regions). The first and second embodiments can be also applied to frame pages including more (less) frames. FIG. 15 shows a frame page DP101 which includes five frames. In the description of the third and following embodiments, this frame page DP101 is employed.

First, the relationship between the frame page DP101 and a plurality of HTML files constituting the frame page DP101 will be described.

As already stated, the frame page consists of at least an HTML file (a frame definition file) which defines the overall configuration of the WWW page (frame structure such as the number of frames and the sizes of the respective frames) and a plurality of HTML files arranged in the respective frames as contents. Further, various files (image files, document files and the like) linked to the respective HTML files are appropriately added to the frame page.

In case of the frame page DP101 shown in FIG. 15, for example, even with a simple configuration in which no various files such as image files and document files are present, the frame page DP101 needs six HTML files, i.e., the HTML file (frame definition file which defines the overall frame configuration of the frame page PD1) DP11 (FIG. 17) and five HTML files arranged in five frames (regions Ba, Bb, Bc, Bd and Be), respectively.

In FIG. 15, boundary lines (including scrawl bars) L1 to L4 appear among the respective regions Ba, Bb, Bc, Bd and Be of the frame page DP101. On an actual frame page, consideration is given to visual effect. Due to this, for example, a uniform base color is often used among different regions or a continuous background pattern without breaks among the regions is often used so as not to display the boundary lines on purpose. For this reason, even if the boundary lines are invisible, it does not follow that the WWW page does not include a plurality of divided regions (does not have a frame structure).

The frame structure defined by the number of divided frames on one screen, the proportions of lengths of the sides of the respective frames (corresponding to the areas of the respective frames in this embodiment), display/non-display of boundary lines or the like, is described in the frame definition file DP111 show in FIG. 17.

FIG. 17 shows the frame definition file DP111 only in an important range to this embodiment. The other ranges, e.g., the header part of the frame definition file DP111, are not shown in FIG. 17.

In this embodiment, data shown in FIG. 17 (the important part of the frame definition file DP111) is given to the region processing section 25b. Alternatively, all the parts of the frame definition file DP111 may be supplied to the region processing section 25b and the region processing section 25b may extract the important part of the frame definition file DP111 shown in FIG. 17.

If the user U1 desires to view the frame page DP101 shown in FIG. 15, the user U1 inputs the URL11 of the frame definition file DP111 to the WWW browser B1 (FIG. 25) of the communication terminal 12b. The communication terminal 12b transmits an HTTP request to request the frame definition file DP111 to be returned, to the WWW server 13. The WWW server 13 which receives this HTTP request returns the frame definition file DP111 as an entity body as well as various HTTP headers (including an entity header) as an HTTP response, to the communication terminal 12b.

If the communication terminal 12b requests the entity body, i.e., such files as HTML files and image files to be returned, the communication terminal 12b designate a GET method and transmits a GET request as the HTTP request.

As stated above, the frame page DP101 shown in FIG. 15 consists of six HTML files, i.e., the frame definition file DP111 and the HTML files DP112 to DP116. The HTML file DP112 is loaded to the region Ba, the HTML file DP113 is loaded to the region Bb, the HTML file DP114 is loaded to the region Bc, the HTML file DP115 is loaded to the region Bd and the HTML file DP116 is loaded to the region Be.

When the communication terminal 12b receives the frame definition file DP111, the WWW browser B1 automatically transmits the HTTP request for requesting the HTML files DP112 to DP114 to the WWW server 13 based on the description (URL112 to URL116) in the frame definition file DP111. The WWW server 13 which receives this HTTP request returns the HTML files DP112 to DP114 to the communication terminal 12b as the HTTP response.

If these six HTML files, i.e., the frame definition file DP111 and the HTML files DP112 to DP116 are processed and reshaped by the WWW browser B1, the frame page DP101 shown in FIG. 15, for example, is displayed on the display screen 24.

As shown in FIG. 17, the URL112 of the HTML file DP112 corresponds to “title.html” in a line TG112, the URL113 of the HTML file DP113 corresponds to “link.html” in a line TG113, the URL114 of the HTML file DP114 corresponds to “honbun.html” in a line TG114, the URL115 of the HTML file DP115 corresponds to “sonota1.html” in a line TG115 and the URL116 of the HTML file DP116 corresponds to “sonota2.html” in a line TG116.

If a plurality of HTML files constituting one frame page are put in the same WWW server (WWW server 13 in this embodiment) as that for the frame definition file and put in the same folder (directory), each HTML file can be designated by a local URL (a URL consisting only of a file name in this embodiment) that does not include an FQDN (Fully Qualified Domain Name).

It is also possible to put a plurality of HTML files constituting one frame page in a different WWW server from that for the frame definition file. In that case, an URL including an FQDN, for example, is used for each HTML file. It is noted that the URL111 for specifying the frame definition file DP111 which the user U1 inputs to the WWW browser B1 normally includes an FQDN.

The URL111 for specifying the frame definition file DP111 is input to the WWW browser B1 not only by user U1's operating the operating section 22 but also by such software as an auto-pilot tool (see Patent Document 1). In the latter case, the user U1 can set a date or a time interval for inputting the URL111 to the WWW browser B1 in advance.

In the HTML file DP113 in the menu (region Bb) belonging to the frame page DP101 (FIG. 15), the name (e.g., “main”) of the frame which a linked file is loaded is designated by a target option in a link tag “<A href”. In this case, if the user U1 selects a link button (“Marketing and Sales Div” or “General Affairs Div.”) arranged in the menu (region Bb), the content of a linked file (e.g., the HTML file DP114 set by the link button is loaded to the region Bc.

If the respective frames are laid out as in the case of the frame page DP101 shown in FIG. 15, the frame name of the region Bb is often designated by a target option in the HTML file DP113 in the menu (region Bb). The frame name is a name allocated to each frame so as to discriminate the respective frames on the frame page. The frame name is described right after the URL of the corresponding HTML file on the frame page. As shown in FIG. 17, the frame name of the frame to which the HTML file DP112 is loaded is described, for example, at a position PS1 right after the URL112 of the HTML file DP112, i.e., “title.html”.

In case of an ordinary frame page having a menu, by clicking on one of the link buttons arranged in the menu, only the content of the frame (region Be) designated as a target is changed without changing the contents of the frames (regions Ba, Bb, Bd and Be in this embodiment) which are not designated as a target. As a result, it appears to the user U1 that a plurality of layered WWW pages exist only in the region Bc.

Up till now, the relationship between the frame page and a plurality of HTML files constituting the frame page has been described while taking the frame page DP101 (FIG. 15) as an example. The communication terminal 12b (FIG. 25) in this embodiment includes the region processing section 25b which functions to determine and extract an important region from a plurality of regions (HTML files) constituting the frame page.

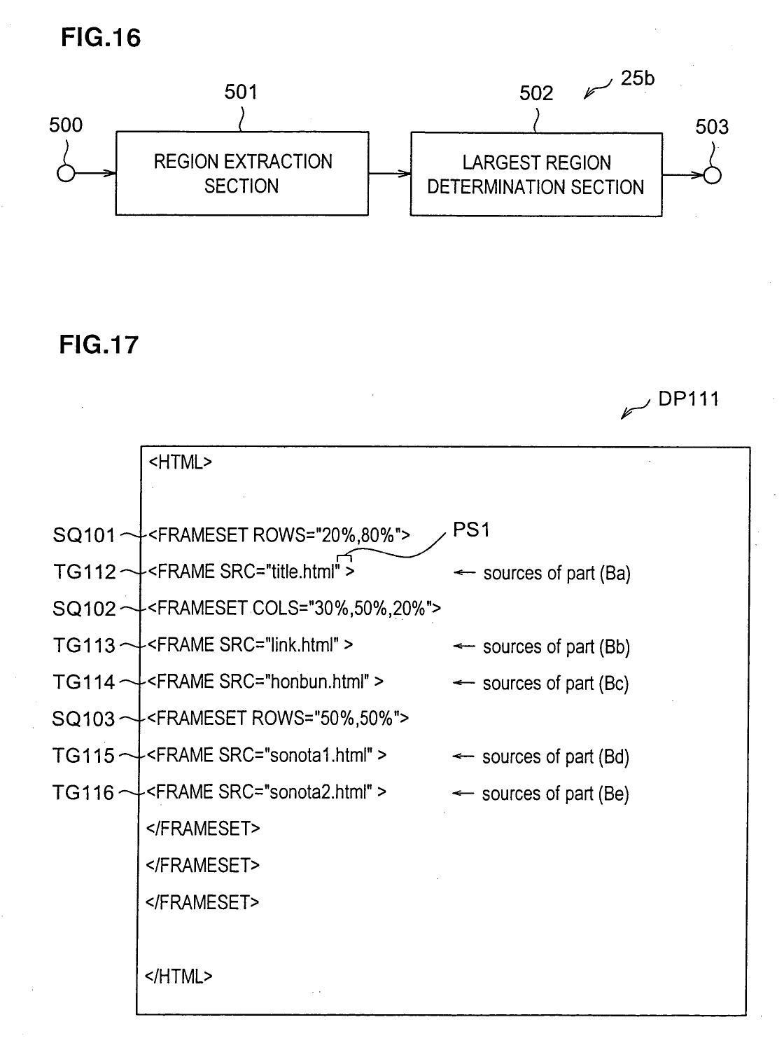

As shown in FIG. 16, this region processing section 25b consists of an input terminal 500, a region extraction section (an attribute information generation section) 501, a largest region determination section (important region select section) 502 and an output terminal 503.

The function of the region processing section 25b is realized by a personal computer having a communication function or the other information processing apparatus. In this embodiment, the region processing section 25b is arranged on the communication terminal (client) 12b side. Alternatively, the region processing section 25b can be arranged on the WWW server 13 side.

Further, in this embodiment, the region processing section 25b is provided separately from the WWW browser B1. Alternatively, the region processing section 25b can be incorporated into the WWW browser B1 as a part of the function thereof.

In this embodiment, “important region” means one region estimated to be the most important region to the user (user U1 in this embodiment) among a plurality of regions on the WWW page. In this embodiment, a region having the largest area is basically set as the important region. In case of the frame page DP101 shown in FIG. 15, for example, one region (region Bc in this embodiment) estimated to be the most important region to the user U1 (to have the largest area) among the regions Ba, Bb, Be, Bd and Be becomes the important region.

Further, the important region may be determined and extracted for a plurality of frame pages which are equal except that only the contents of the target frame (e.g., the region Bc) are changed so as to correspond to a typical method for using a frame page having a menu (which is the region Bb in case of the frame page DP101). In this case, no complicated processing is required according to this embodiment.

The HTML file (e.g., frame definition file DP111) transmitted from the WWW server 13 is input to the input terminal 500 which constitutes the region processing section 25b. Depending on the relationship between the region processing section 25b and the WWW browser B1, the direct supplier of the HTML file to this input terminal 500 may possibly differs.

For example, if the region processing section 25b cooperates with the WWW browser B1 and receives the HTML file transmitted from the WWW server 13 via the WWW browser B1, the direct supplier of the HTML file to the input terminal 500 is the WWW browser B1. On the other hand, if the region processing section 25b is an HTTP client independent of the WWW browser B1 and receives the HTML file not via the WWW browser B1, the direct supplier of the HTML file to the input terminal 500 might be the OS incorporated into the control section 21.

The region extraction section 501 connected to the input terminal 500 has a function of analyzing control characters related to region division (frame structure) included in the input HTML file to thereby extract divided regions and calculating the display area of each divided region. The areas calculated here are supplied, as determination basic standard, to the largest region determination section 502.

The areas of the respective regions Ba, Bb, Bc, Bd and Be constituting the frame page DP101 can be calculated based on line SQ101, SQ102 and SQ103 (FIG. 17) described in the frame definition file DP11.

To be specific, first, the description of the line SQ101 of the frame definition file DP111 shown in FIG. 17 demonstrates that the entire region of the frame page DP101 shown in FIG. 15 is divided by the boundary line L101 in an arrow D1 direction with a proportion of 20% and 80% (2:8). Next, the description of the line SQ102 of the frame definition file DP1 demonstrates that regions other than the region Ba of the frame page DP101 are divided by the boundary lines L102 and L103 in an arrow D2 direction with a proportion of 30%, 50% and 20% (3:5:2). Further, the description of the line SQ103 of the frame definition file DP1 l demonstrates that regions other than the regions Ba, Bb and Bc of the frame page DP101 are divided by the boundary lines L104 in an arrow D3 direction with a proportion of 50% and 50% (5:5).

To designate the frame structure (division proportion), the number of pixels besides percentage (%) can be used. In either case, it is possible to obtain the areas of the respective regions Ba, Bb, Bc, Bd and Be of the frame page DP101 shown in FIG. 15 based on the contents of the lines SQ101, SQ102 and SQ103 of the frame definition file DP111.

It is noted that the absolute areas of the respective regions Ba, Bb, Bc, Bd and Be of the frame page DP101 on the display section (e.g., liquid crystal display) 24 depend on the resolution of the display section 24. That is, as the resolution of the display section 24 is higher, the respective regions are displayed with smaller areas. “Absolute area” means an area represented by such a unit as cm² or mm².

To obtain the absolute areas of the respective regions, it is preferable to give information on the resolution of the display section 24 to the region extraction section 501 in advance.

In this embodiment, the areas of the respective regions are obtained so as to select the largest region from among a plurality of regions. Due to this, the calculated areas are not necessarily absolute areas. It suffices to obtain relative areas effective only to one frame page. If the relative areas (proportions of the areas of the respective regions) are obtained, such information as resolution is unnecessary, thereby simplifying the area calculation processing performed by the region extraction section 501.

When calculating the proportions of the areas of the respective regions or the absolute areas thereof, the region extraction section 501 supplies the calculation result, as the determination basic information, to the largest region determination section 502 in a predetermined order.

In this embodiment, it is assumed that the determination basic information is supplied to the largest region determination section 502 faster as the information is on an upper region on the screen and supplied to the largest region determination section 502 faster as the information is on a region closer to the left side on the screen while region height is equal. In case of the frame page DP101 shown in FIG. 15, respective pieces of determination basic information on the regions Ba, Bb, Be, Bd and Be are supplied to the largest region determination section 102 in this order. It is noted, however, that the order of supplying the determination basic information is not limited to the above order as long as there is a matching between the region extraction section 501 and the largest region determination section 502.

The largest region determination section 502 functions to determine an important region on one frame page based on the received determination basic information.

Meanwhile, the region extraction section 501 supplies the HTML files DP112 to DP116 which show the contents of the respective regions Ba to Be together with the respective pieces of determination basic information to the largest region determination section 502. Alternatively, the region extraction section 501 may supply identification information on the respective HTML files DP112 to DP116 instead of the HTML files DP112 to DP116. As the identification information, the URL112 to URL116 (file names) of the respective HTML files DP112 to DP116, for example, can be used.

If the region extraction section 501 supplies not the HTML files DP112 to DP116 but the respective pieces of identification information on the HTML files DP112 to DP116 to the largest region determination section 502, it is preferable that the HTML files DP112 to DP116 are stored in, for example, a cache region in the storage section 23 of the communication terminal 12b. By doing so, after determining the important region, the largest region determination section 502 can fetch only the HTML file (e.g., HTML file DP114) corresponding to the important region from the cache region in the storage section 23.

Alternatively, the region processing section 25b can be constituted so that the largest region determination section 502 does not directly deal with the HTML files. In this case, after determining the important region, the largest region determination section 502 outputs only the identification information on the HTML file corresponding to the important region. An image display module (e.g., the WWW browser B1) responsible for the display of the determined important region on the screen, fetches the HTML file corresponding to the important region from, for example, the cache region in the storage section 23 based on the identification information output from the largest region determination section 502 and displays the HTML file on the screen.

The output terminal 503 is electrically connected to the image display module (e.g., the WWW browser B1). The HTML file corresponding to the important region determined by the largest region determination section 502 or the identification information on the HTML file is supplied to the image display module through this output terminal 503.

The operation of the communication system constituted as stated above in this embodiment, particularly, the operation of the region processing section 25b which belongs to the communication terminal 12b will now be described.

First, when the URL111 is input to the WWW browser B1 by the user U1's operating the operating section 22 or the function of the auto-pilot tool or the like, the WWW browser B1 transmits an HTTP request (a GET request) corresponding to the URL111 to the WWW server 13.

If the region processing section 25b has a function as an HTTP client separately from the WWW browser B1, the URL111 is input not to the WWW browser B1 but to the region processing section 25b.

If receiving this HTTP request transmitted from the communication terminal 12b via the Internet 11, the WWW server 13 (server OS) fetches the frame definition file DP111 designated by the URL111 from the storage section 32. The WWW server 13 returns an HTTP response including the frame definition file DP111 as an entity body to the communication terminal 12b.

If the communication terminal 12b receives the frame definition file DP111, the WWW browser. B1 automatically, sequentially transmits the respective HTTP requests to the WWW server 13 based on the description (URL112 to URL114) given in the frame definition file DP111. The WWW server 13 transmits the HTML files DP112 to DP114 which constitute the frame page DP101 as entity bodies of the HTTP response to the respective HTTP requests, to the communication terminal 12b. The HTML files DP112 to DP114 are read by the region processing section 25b which belongs to the communication terminal 12b. Alternatively, the frame definition file DP111 shown in FIG. 17 may be read by the region processing section 25b in place of the HTML files DP112 to DP114.

As stated above, the proportions of areas (area proportions) or absolute areas as the determination basic information can be calculated from the description of the frame definition file (frame definition file DP111 in this embodiment). Therefore, the frame definition file DP111 may be input to the region extraction section 501 included in the region processing section 25b without inputting the HTML files DP112 to DP116.

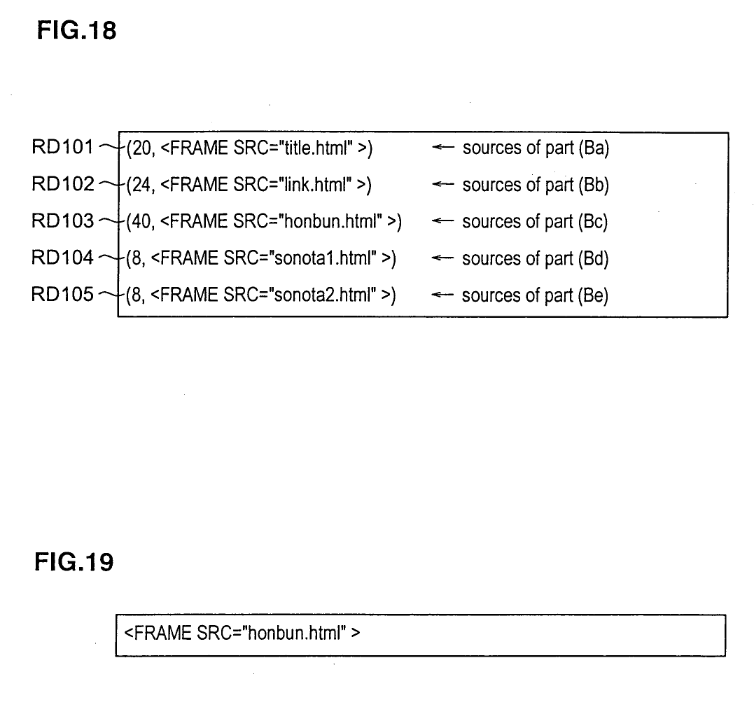

If receiving the frame definition file DP111 shown in FIG. 17, the region extraction section 501 outputs the determination basic information shown in FIG. 18 as a result of processing the file DP111.

Records RD101 to RD105 in the determination basic information shown in FIG. 18 are described based on the following record configuration (R1).

(Divided region area, Divided region′ URL) . . . (R1)

The divided region area shows not the absolute area as described above but the proportion of the area of the respective each region with the entire area of the frame page DP101 assumed as 100.

To be specific, 20% of the entire range of the frame page DP101 is allocated to the region Ba according to the description of the line SQ101 in the frame definition file DP111 shown in FIG. 17. Accordingly, in the record RD101 in the determination basic information shown in FIG. 18, the proportion of the area of the region Ba “20” and the URL112 of the HTML file DP112 loaded to the region Ba are described.

Likewise, 30% of 80% of the entire range of the frame page DP101 obtained by excluding 20% allocated to the region Ba from the entire range thereof is allocated to the region Bb, 50% thereof is allocated to the region Bc according to the description of the line SQ102 in the frame definition file DP111 shown in FIG. 17. Accordingly, in the record RD102 in the determination basic information shown in FIG. 18, the proportion of the area of the region Bb “24” (=0.8×0.3×100) and the URL113 of the HTML file DP113 loaded to the region Bb are described. In the record RD103, the proportion of the area of the region Bc “40” (=0.8×0.5×100) and the URL114 of the HTML file DP114 loaded to the region Bc are described.

As for the regions Bd and Be, the area proportions thereof “8” are obtained by the same calculation. As a result, in the record RD104 in the determination basic information shown in FIG. 18, the proportion of the area of the region Bd “8” and the URL115 of the HTML file DP115 loaded to the region Bd are described. In the record RD105, the proportion of the area of the region Be “8” and the URL116 of the HTML file DP116 loaded to the region Be are described.

In this embodiment, one of the URL112 to URL116 of the respective HTML files DP112 to DP116 is described as it is for “divided area's URL” in the record configuration (R1). The respective records RD101 to RD105 are transmitted, as the determination basic information, to the largest region determination section 502. It is noted that the URL112 to 116 are also used as the identification information which is the result of the determination processing performed by the largest region determination section 502.

The largest region determination section 502 which receives the records RD101 to RD105 determines which region has the largest area among the regions Ba to Be. In this determination processing, the area proportions described in the records RD101 to RD105 are used. By using this determination method, it is possible to easily, quickly, accurately recognize that the region Bc with the area proportion of 40(%) is the region having the largest area. As the result of this determination processing, the largest region determination section 502 outputs identification information shown in FIG. 19. This identification information includes the URL114 of the HTML file DP114 loaded to the region Bc which is determined by the largest region determination section 502.

Based on the identification information output from the largest region determination section 502 which belongs to the region processing section 25b, the image display module (e.g., the WWW browser B1) acquires the HTML file DP114 specified by the URL114 from the cache region in the storage section 23 and displays the acquired HTML file DP114 on, for example, the display section 24.

As described so far, according to the third embodiment, the important region is automatically determined from a plurality of regions which constitute the frame page based on the viewpoints that the most important region (important region) is a region having the largest area.

Due to this, it is unnecessary for the user to manually designate the start point and end point of extracted data to the system in advance. It is thereby possible to lessen operation burden on the user. It is also possible to facilitate selecting only the important regions from multiple frame pages and outputting the selected important regions.

Further, according to the third embodiment, the important region is automatically determined from a plurality of regions which constitute the frame page. Due to this, in notifying the user of the update of a designated web page, for example, it is possible to facilitate establishing a service system for excluding the update of the regions other than the important region from a notification target. It is also possible to facilitate establishing a search system for excluding the regions other than the important region from a search target or providing a document scrap service for setting only the important region as a summary target.

The important region determination processing executed by the region processing section 25b in this embodiment is to simply compare areas or area proportions and the operation quantity of the processing is quite small. It is, therefore, possible to quickly obtain the important region determination result.

In the information processing in this embodiment, there is no need to use a natural language. It is, therefore, possible to determine the important region without depending on the description language (the description of the bodies of the HTML files).

Moreover, according to this embodiment, the frame definition file DP111 is analyzed based only on the pre-designated ranges (line SQ101 to SQ103 and line TG112 to TG116). Namely, the entire range of the frame definition file DP111 is not analyzed, so that the processing quantity of information necessary for the analysis of the frame definition file DP111 is small. Consequently, it is possible to efficiently determine the important region.

### Fourth Embodiment

In the third embodiment, the important region is determined based on the areas (area proportions or absolute areas) of the respective regions which constitute the frame page. In the fourth embodiment, the important region is determined based on the position of the frame page (e.g., frame page DP101) displayed on the screen. To be specific, a region arranged at a position near the center of the frame page displayed on the screen is selected as an important region from among a plurality of regions which constitute the frame page.

A communication terminal 12c in this embodiment differs in configuration from the communication terminal 12b in the third embodiment shown in FIG. 25 in that the region processing section 25 is replaced by a region processing section 25c. It is noted that the network 11 (FIG. 24) and the server 13 (FIG. 26) constitute this embodiment similarly to the preceding first to third embodiments.

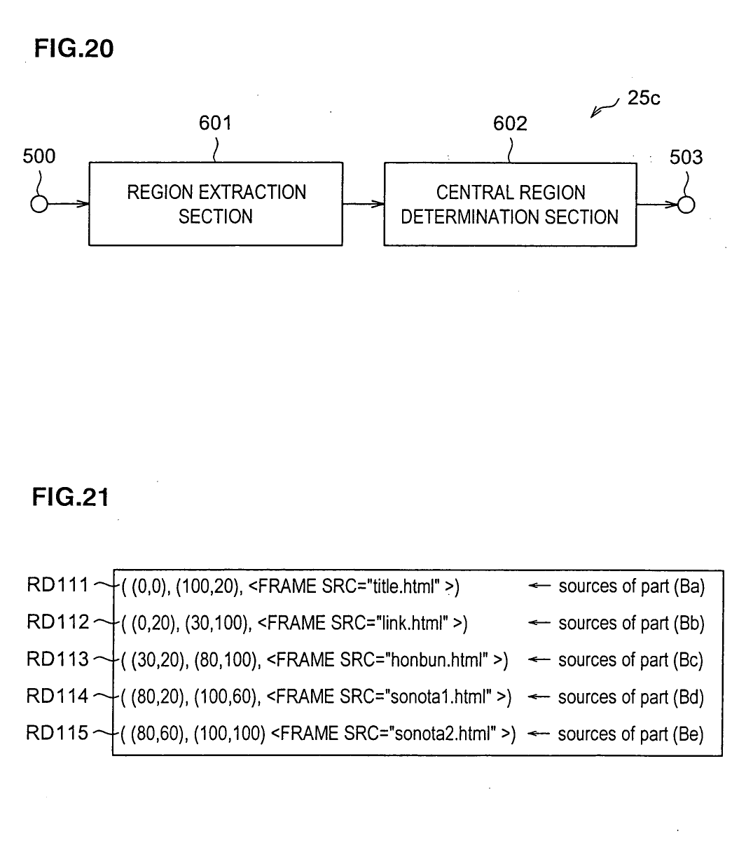

As shown in FIG. 20, the region processing section 25c included in the communication terminal 12c consists of the input terminal 500, a region extraction section (attribute information generation section) 601, a central region determination section (important region select section) 602 and the output terminal 503.

The region extraction section 601 has a function of analyzing control characters related to region division and described in the frame definition file DP111 input to the region processing section 25c to thereby extract divided regions and calculating position information indicating the positions of the respective regions.

As shown in FIG. 15, in this embodiment, the two-dimensional positions of the respective regions are expressed by a coordinate in the arrow D1 direction and the arrow D2 direction if a point P0 on the upper left end of the screen is set as an origin. Specifically, the two-dimensional positions of the respective regions are expressed by (D2 direction coordinate, D1 direction coordinate). It is assumed herein that the minimum values of the coordinates in the arrow D 1 and arrow D2 directions are the origin P0 of “0” and the maximum values thereof are “100”. Alternatively, the positions of the respective regions can be defined using the other expression method.

Further, since the respective regions are all rectangular regions, the positions and sizes of the respective regions can be specified using the two-dimensional positions (coordinates) of the upper left end and lower right end of the regions. It is also possible to indirectly express the position of the center of each region.

In this embodiment, the two-dimensional positions of the regions Ba to Be which constitute the frame page DP101 are expressed as records RD111 to RD115 in determination basic information shown in FIG. 21, respectively.

Records RD111 to RD115 in the determination basic information shown in FIG. 21 are described based on the following record configuration (R2).

(Coordinate of upper left end point of divided region, Coordinate of lower right end point of divided region, URL of divided region) . . . (R2)

As for the region Ba, for example, the upper left end point thereof coincides with the origin P0 of the frame page DP101, the coordinate of the upper left end point is (0, 0) and that of the lower right end point P1 is (100, 20). Therefore, coordinate (0, 0) and coordinate (100, 20) are described in the record RD111 in the determination basic information shown in FIG. 21. The coordinate component “20” in the arrow D1 direction can be calculated based on the description of the line SQ101 in the frame definition file DP111 shown in FIG. 17.

The coordinates of the upper left end points and lower right end points of the regions Bb to Be can be expressed in a similar fashion to the region Ba.

The coordinate of the upper left end point P2 of the region Bb is (0, 20) and that of the lower right end point P3 thereof is (30, 100). The coordinate of the upper left end point P4 of the region Bc is (30, 20) and that of the lower right end point P5 thereof is (80, 100). The coordinate of the upper left end point P6 of the region Bd is (80, 20) and that of the lower right end point P7 thereof is (100, 60). The coordinate of the upper left end point P8 of the region Be is (80, 60) and that of the lower right end point P9 thereof is (100, 100).

The coordinates of the upper left end points and lower right end points of the regions Bb to Be are described in the records RD112 to RD115 in the determination basic information shown in FIG. 21, respectively.

The region extraction section 601 which belongs to the region processing section 25c generates the records RD111 to RD115 (determination basic information) based on the data (the important parts of the frame definition file DP11) shown in FIG. 17 and supplies the generated records RD111 to RD115 to the central region determination section 602.

In this embodiment, it is assumed that this determination basic information is supplied to the central region determination section 602 faster as the information is on an upper region on the screen and supplied to the central region determination section 602 faster as the information is on a region closer to the left side on the screen while region height is equal. In case of the frame page DP101 shown in FIG. 15, respective pieces of determination basic information on the regions Ba, Bb, Be, Bd and Be are supplied to the central region determination section 602 in this order. It is noted, however, that the order of supplying the determination basic information is not limited to the above order as long as there is matching between the region extraction section 601 and the central region determination section 602.

The central region determination section 602 supplied with the determination basic information analyzes the records RD111 to RD115 included in the determination basic information and calculates the distance between the center of each of the regions Ba to Be and the center of the screen of the display section 24 (center of the frame page DP101) CP. The central region determination section 602 determines that the region the center of which is located closer to the center CP is the important region.

If the window of the WWW browser B1 (browser window) is displayed in a small size and moved on the screen of the display section 24 (e.g., liquid crystal display), the center of the screen of the display section 24 does not coincide with the center of the browser window (or the center of the frame page). Due to this, it is preferable that the central region determination section 602 calculates the distance of the center of each of the regions Ba to Be to not the center of the screen of the display section 24 but the center of the frame page (frame page DP101 in this embodiment) or that of the browser window.

As described above, if the coordinate of the origin P0 is set at (0, 0) and that of the point P9 is set at (100, 100), the coordinate of the center CP of the frame page DP101 is (50, 50). The central region determination section 602 obtains the distance between the coordinate of the center of each of the regions Ba to Be and the coordinate (50, 50) of the center CP of the frame page DP101.

Normally, the distance between the two points in the browser window is expressed by using cm, mm, pixels or the like. In this embodiment, the distances between the centers of the regions Ba to Be and the center CP of the frame page DP101 are compared relatively without using absolute values based on such a unit. In the third embodiment, the area proportions are adopted as a basis for the determination of the important region, whereby operation load on the largest region determination section 502 is lessened. Likewise, in this embodiment, the relative distances (distance proportions) are adopted as a basis for the determination of the important region, whereby operation load on the central region determination section 602 is lessened.

The coordinates of the upper left end points and lower right end points of the regions are described in the records RD111 to RD115 (determination basic information) shown in FIG. 21, respectively. The coordinate of the center of each region can be easily obtained by calculating the averages of the D2 component of the upper left end point and D2 component of the lower right end point and those of the D1 component of the D1 component of the upper left end point and D1 component of the lower right end point.

The coordinate of the center of the region Ba is obtained by calculating the averages of the D2 components and D1 components of the upper left end point P0 (0, 0) and the lower right end point P4 (100, 20). Specifically, the coordinate of the center of the region Ba is (50, 10).

The coordinate of the center of the region Bc is obtained by calculating the averages of the D2 components and D1 components of the upper left end point P4 (30, 20) and the lower right end point P5 (80, 100). Specifically, the coordinate of the center of the region Be is (55, 60).

As for the other regions Bb, Bd and Be, the coordinates of the centers thereof can be obtained by the same processing as that described above.

In case of the frame page DP11 shown in FIG. 15, the coordinate (55, 60) of the center of the region Bc is closest to the coordinate (50, 50) of the center CP of the frame page DP101. Therefore, the central region determination section 602 determines that the region Be is the important region. Further, the central region determination section 602 outputs the URL114 of the HTML file DP114 loaded to the region Bc from the output terminal 503.

As described so far, according to the fourth embodiment, the important region is automatically determined from a plurality of regions which constitute the frame page based on the viewpoints that the most important region (important region) is the region closest to the center of the frame page.

Further, this embodiment can attain the same advantages as those of the third embodiment.

### Fifth Embodiment

In the third embodiment, the important region is determined based on the areas (area proportions or absolute areas) of the respective regions which constitute the frame page. In the fourth embodiment, the important region is determined based on the position of the frame page displayed on the screen. In the fifth embodiment, the important region is determined using a combination of these two bases.

A communication terminal 12d in this embodiment differs in configuration from the communication terminal 12b the third embodiment shown in FIG. 25 in that the region processing section 25 is replaced by a region processing section 25d. It is noted that the network 11 (FIG. 24) and the server 13 (FIG. 26) constitute this embodiment similarly to the preceding first to fourth embodiments.

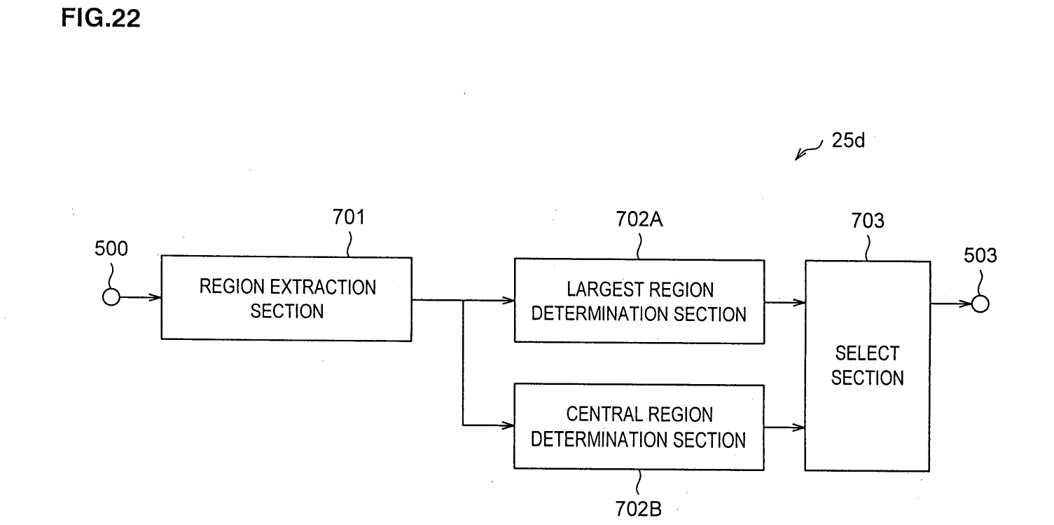

As shown in FIG. 22, the region processing section 25d included in the communication terminal 12d consists of the input terminal 500, a region extraction section (attribute information generation section) 701, a largest region determination section 702A, a central region determination section 702B, a select section 703 (important region select section) and the output terminal 503.

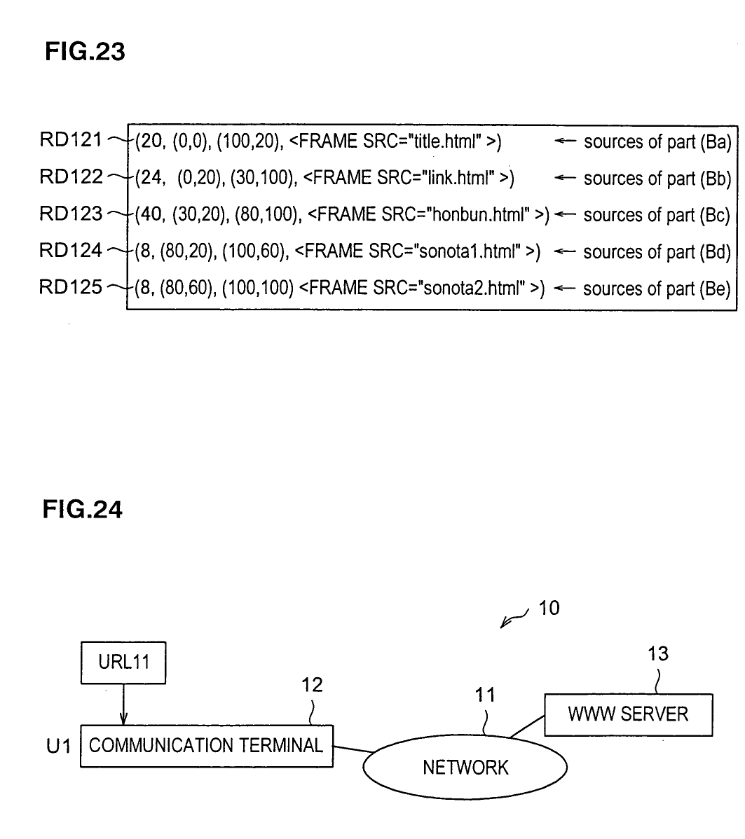

The region extraction section 701 has both the function of the region extraction section 501 (FIG. 16) in the third embodiment and that of the region extraction section 601 (FIG. 20) in the fourth embodiment. For example, when receiving the frame definition file DP111 shown in FIG. 17, the region extraction section 701 outputs records RD121 to RD125 shown in FIG. 23. Alternatively, the region extraction section 701 may be constituted to output the records RD101 to RD105 shown in FIG. 18 and the records RD111 to RD115 shown in FIG. 21 in place of the records RD121 to RD125.

The records RD121 to RD125 in determination basic information shown in FIG. 23 are described based on the following record configuration (R3).

(Area of divided region, Coordinate of upper left end point of divided region, Coordinate of lower right end point of divided region, URL of divided region) . . . (R3)

Both the largest region determination section 702A and the central region determination section 702B receive the records RD121 to RD125 (determination basic information) from the region extraction section 701. If the region extraction section 701 outputs the records RD101 to RD105 and RD111 to RD115, both the largest region determination section 702A and the central region determination section 702B receive the records RD101 to RD105 and RD111 to RD115. Alternatively, the region extraction section 701 may be constituted to selectively transmit the records RD101 to RD105 to the largest region determination section 702A and selectively transmit the records RD111 to RD115 to the central region determination section 702B.

The largest region determination section 702A has a function of, similarly to the largest region determination section 502 in the third embodiment, calculating the areas (area proportions or absolute areas) of the respective regions Ba to Be which constitute the frame page DP101.

It is noted, however, that the largest region determination section 702A has a function of transferring the records RD111 to RD115 to the select section 703 provided in rear of the section 702A if receiving the records RD111 to RD115 which are not employed to calculate the areas of the respective regions Ba to Be from the region extraction section 701 provided in front of the section 702A. This is the functional difference between the largest region determination section 702A and the largest region determination section 502.

The largest region determination section 702A can select a record (e.g., RD113) corresponding to a region (e.g., region Bc) having the largest area from among the records RD111 to RD115. In this case, the largest region determination section 702A supplies only the selected record together with the URL of the HTML file loaded to the region having the largest area, to the select section 703. This can lessen processing load on the select section 703.

If receiving the records RD121 to RD125 from the region extraction section 701, the largest region determination section 702A preferably selects a record (e.g., RD123) corresponding to a region (e.g., region Bc) having the largest area from among the records RD121 to RD125 and supplies only the selected record to the select section 703.

The central region determination section 702B has a function of, similarly to the central region determination section 602 in the fourth embodiment, calculating the distance (absolute or relative distance) between the center of each of the respective regions Ba to Be which constitute the frame page DP101 and the center CP of the frame page DP101.

It is noted, however, that the central region determination section 702B has a function of transferring the records RD101 to RD105 to the select section 703 provided in rear of the section 702B if receiving the records RD101 to RD105 which are not employed to calculate the distances from the region extraction section 701 provided in front of the section 702B. This is the functional difference between the central region determination section 702B and the central region determination section 602.

The central region determination section 702B can select a record (e.g., RD103) corresponding to a region (e.g., region Bc) having a center at the closest position to the center CP of the frame page from among the records RD101 to RD105. In this case, the central region determination section 702B supplies only the selected record together with the URL of the HTML file loaded to the region having the center at the closest position to the center CP of the frame page, to the select section 703. This can lessen processing load on the select section 703.

If receiving the records RD121 to RD125 from the region extraction section 701, the central region determination section 702B preferably selects a record (e.g., RD123) corresponding to a region (e.g., region Bc) having a center at the closest position to the center CP of the frame page from among the records RD121 to RD125 and supplies only the selected record to the select section 703.

The select section 703 executes a select processing according to the following formula (F2) based on the data (records) supplied from the largest region determination section 702A and the central region determination section 702B.

V=Xα+Yβ (F2).

In the formula (F2), X denotes area and Y denotes the inverse of the distance between the center CP of the frame page and the center of each region. In addition, α and β are weighting factors. The factors α and β can be adjusted so as to be able to obtain a use's expected result.

The select section 703 assigns the data input from the largest region determination section 702A to the formula (F2) to obtain a value V1. The select section 703 assigns the data input from the central region determination section 702B to the formula (F2) to obtain a value V2. The select section 703 compares the values V1 and V2. If the value V1 is higher than V2, for example, it is determined that the region corresponding to the data input from the largest region determination section 702A is the important region. The select section 703 then outputs identification information (URL) on the HTML file loaded to the important region from the output terminal 503.

It is noted that the select processing needs to be performed by the select section 703 when the determination result of the largest region determination section 702A differs from that of the central region determination section 702B. Therefore, if the both determination results coincide, the select processing of the select section 703 using the formula (F2) may be omitted.

As described so far, the fifth embodiment can attain the same advantages as those of the third and fourth embodiments.

There is a probability that the region determined as the important region in the third embodiment differs from the region determined as the important region in the fourth embodiment, depending on the frame structure of the frame page. Even so, according to the fifth embodiment, one important region is automatically determined from among a plurality of regions which constitute the frame page.

Further, according to this embodiment, the user can select the weighting factors α and β of the formula (F2). Accordingly, the important region coincident with the user's expectation is elected.

The preferred embodiments of the present invention have been described so far with reference to the accompanying drawings. However, the present invention is not limited to these embodiments. It is obvious that a person having ordinary skill in the art can easily contrive various changes and modifications within the scope of the technical concept defined in the claims which follow, it is appreciated that these changes and modifications are also, naturally within the technical scope of the present invention.

In the first and second embodiments, the region processing section 25 is constituted to divide the files read by the region processing section 25 and store the divided files so as to compare the files later read by the region processing section 25. Alternatively, the files read thereby may be stored as they are (without dividing them) and divided just before the files are actually compared.

In the first and second embodiments, the respective regions are made correspond according to the order described in the composite file SP1. However, the information (URL12 to URL14) which enables the regions to be discriminate from one another is added to each region in the frame definition file DP11. Therefore, using the identification information, the respective regions may be made to correspond to one another.

In the second embodiment, the checksum of the respective HTML files is used to detect the update frequency of each region. It is also possible to use signs for error detection besides the checksum. Further, a value (hash value) obtained by converting the content of the file using a hash function may be used in place of the checksum.

The first to fifth embodiments have been described while referring to a case where the GET request (GET method) is used as the HTTP request. Alternatively, a HEAD request (HEAD method) may be used.

An HTTP response to the HEAD request is the same as the HTTP response to the GET request except that the HTTP response to the HEAD request does not include an entity body (file). Therefore, even if the communication terminal 12 transmits the HEAD request, the communication terminal 12 can acquire the term-of-validity information, update date information or the like included in the entity head from the WWW server 13.

In this case, the communication terminal 12 can detect whether each file has been updated based on the term-of-validity information, update date information or the like. In addition, if the HEAD request is used, it is unnecessary to deal with the file body large in size, so that load is lessened both on the WWW server 13 side and the communication terminal 12 side and communication traffic is decreased. Furthermore, since response time is shortened, it is possible to realize the acceleration of information processing.

Furthermore, it is possible to combine the file update detection method based on the comparison of the file body or the checksum thereof with the file update detection method based on the update date information. If the user U1 desires to view a frame page and manually inputs URL111, for example, the file bodies are compared using the GET request. By contrast, if the auto-pilot tool or the like automatically detects whether file update is performed, the update date information is acquired using the HEAD request to thereby detect whether file update is performed based on this acquired update date information.

The various pieces of information, such as term-of-validity information and update date information, included in the HTTP header is updated based on the management information collected by the WWW server 13. If the WWW server 13 does not properly manage files, the management information may possibly become incorrect. For example, there is a probability that the file update date is rewritten and update date information is generated as if update is performed although the content of the file is not at all changed.

To avoid this, by detecting whether file update is performed using the content of the file body or the checksum thereof, it is possible to correctly calculate the update frequency of the file even if various pieces of information included in the HTTP header are incorrect.

While the frame definition file DP11 shown in FIG. 4A is on a top page (index.html), the present invention is also applicable to the frame definition file on a page other than the top page.

According to the fifth embodiment, the region select processing is performed according to the formula (F2). Alternatively, the region select processing may be performed according to the other formula.

For example, the following formula (F3) can be used.

V=XY (F3)

In the formula (F3), X denotes area and Y denotes the inverse of the distance between the center CP of the frame page and the center of each region.

Further, in the fifth embodiment, the select section 703 uses the value calculated based on the areas and position information for the region select processing. Alternatively, the region select processing can be performed using the other information. For example, attention may be paid to characters (e.g. a character string) equal in type and size and displayed in each region and a region having more such characters (character string) may be selected as the important region.

In the first to fifth embodiments, the order of outputting determination results related to the respective region from the region extraction section is not limited to the above-stated order. For example, the order may be according to the order of raster scan for sequentially moving from divided regions right to left and up to down or according to the opposite order to that of the raster scan.

In the third and fifth embodiments, it is preferable to calculate the area proportions or absolute areas of the respective contents (HTML files) displayed on the screen including image scrawling degrees thereof so as to determine the important region.

Generally, if an HTML file is displayed on the screen and the file is displayed large in a vertical direction to the screen (in the arrow D1 direction of FIG. 15), a vertical scrawl bar for vertical scrawling automatically appears on the screen. If the HTML file is displayed large in a horizontal direction to the screen (in the arrow D2 direction of FIG. 15), a horizontal scrawl bar for horizontal scrawling automatically appears on the screen. The user can check the entire HTML file by operating the vertical scrawl bar and the horizontal scrawl bar.

If all the tags contained in a HTML file are interpreted and appropriate operation is performed, it is possible to highly accurately calculate the area proportion or absolute area of each HTML file including the scrawling decree thereof.

Further, the displayed area proportion or absolute displayed area of each HTML file including the scrawling degree thereof e obtained using the file size of the HTML file.

However, if the description of control characters such as tags which are not to be directly displayed on the screen increases, the file size of the HTML file becomes large even with the area displayed on the screen unchanged. In addition, with the file size of the HTML file unchanged, even if a large font is designated or wide line spacing is set, the displayed area of the HTML file including the scrawling degree thereof increases. In this case, the file size of the HTML file does not correctly correspond to the displayed area or area proportion of the HTML file. Nevertheless, if the proportion of the control characters in each HTML file does not greatly differ among the HTML files and the content of the designated font or the layout of character strings does not greatly differ among the HTML files, the file size of each HTML file serves as a good schematic index for indicating the area proportion or absolute area of each HTML file.

The file size is included in the information described on the entity header in the HTTP header included in the HTTP response. Therefore, the file size can be easily acquired.

This entity body also includes information related to file format. Using this information, it is possible to exclude linked image files and compare only the file sizes of the HTML files even if image files or the like are linked to some of the HTML files (e.g., DP112 to DP116) which constitute the frame page as a part of the region.

Furthermore, in the third and fifth embodiment, it is preferable to provide the region processing section 25 with a standard specification (e.g., the resolution of the display section) if the absolute are of each region is obtained. By doing so, even if the display serving as the display section 24 is replaced by a display of new type, it is unnecessary to provide the content of the specification of the new display to the region processing section 25 whenever the display is replaced by another.

As shown in FIGS. 1 and 15, on the typical frame page, the menu is arranged in a narrow frame such as the region Ab or Bb and the contents changing according to the selection of the menu are loaded to a wide frame such as the region Ac or Bc. The present invention is applicable not only to the frame page having such a menu but also to a frame page without a menu.

The present invention is also applicable to a WWW page other than the frame page. In addition, the present invention is applicable to a WWW page described in a language other than the HTML language, e.g., XML (extensible Markup Language) or SGML (Standard Generalized Markup Language). The present invention is applied to a structured document which includes a plurality of regions that can be logically discriminated.

As for a WWW page including a plurality of images (image files), for example, one of the image files may be determined as an important region based on the update frequencies of the respective image files. In addition, the update frequencies of an HTML file as a basis and images (image files) related to the HTML file and displayed on the WWW page are detected, respectively, and one of the files can be selected as an important region. In this case, if one of the images (image files) is selected as the important region, only the selected image may be displayed on the display section 24. If the HTML file is selected, the HTML file including images may be displayed on the display section 24.

The regions may be discriminated based on a unit (e.g., directly) other than the files.

Furthermore, FTP (file transfer protocol), for example, other than the HTTP may be employed as the data communication protocol between the communication terminal 12 and the WWW server 13.

In the first to fifth embodiments, the region processing section 25 (25a, 25b, 25c or 25d) is arranged on the side of the communication terminal (client) 12 (12a, 12b, 12c or 12d). Alternatively, the function of the region processing section 25 can be incorporated into the WWW server 13. Further, the function of the region processing section 25 can be incorporated into a server, e.g., a proxy server, located between the WWW server 13 and the communication terminal 12.

If the region processing section 25 is particularly arranged on the WWW server 13 side, it is not always necessary to use HTTP for the data communication between the WWW server 13 and the region processing section 25. The file management information managed by the server OS mounted on the WWW server 13 can be used as it is to detect whether each file has been update.

Moreover, the first to fifth embodiments have been described on the premise that the frame page is made open on the WWW server 13. The present invention is also applicable to a frame page obtained from a recording medium such as a CD-ROM. Namely, the structured document to which the present invention is applied is not necessarily acquired through the network.

Further, a formula for incrementing (or decrementing) the update frequency whenever file update is detected may be adopted in place of the formula (F1) used in the first embodiment.

The present invention can be constituted as either hardware or software.

What is claimed is:

1. An information processing apparatus for determining a key region from a structured document including a plurality of regions, the apparatus comprising:
a read section acquiring contents or management information of the regions included in said structured document at time series for a plurality of number of times;
a storage section storing the contents or management information of the regions acquired by the read section;
a comparison and check section comparing the contents or management information of the corresponding regions among the contents or management information of the regions acquired by the read section, and checking whether each of the regions has been updated based on a comparison result;
an update frequency calculation section calculating update frequency information for each of the regions based on a history of a check result of the comparison and check section; and
a key region determination section determining the key region from the plurality of regions included in said structure document based on the update frequency information.

2. The information processing apparatus according to claim 1, comprising a boundary division section dividing the respective regions included in said structured document based on boundary information on boundaries among the regions displayed on a screen, wherein said read section reads the contents or management information of said respective regions by cooperating with the boundary division section.

3. The information processing apparatus according to claim 1, comprising a region management section discriminating the respective regions using an inter-region structure if the inter-region structure showing a logic structure between the regions is defined for each of the regions included in said structured document, wherein
said read section reads the contents or management information of said respective regions by cooperating with the region management section.

4. The information processing apparatus according to claim 1, wherein
said comparison and check section compares the content of one of the regions acquired by said read section at one reading time with the content of said one region acquired at a different reading time, and thereby checks whether said one region has been updated.

5. The information processing apparatus according to claim 1, wherein
said comparison and check section compares the management information of one of the regions acquired by said read section at one reading time with the management information of said one region acquired at a different reading time, and thereby checks whether said one region has been updated.

6. The information processing apparatus according to claim 1, comprising a conversion section converting said contents or management information of the regions into converted date, and outputting said converted data to said storage section.

7. The information processing apparatus according to claim 1, wherein
said update frequency calculation section calculates new update frequency information based on previous update frequency information and the check result newly output from said comparison and check section.

8. An information processing method for determining a key region from a structured document including a plurality of regions, wherein
a read section acquires contents or management information of the regions included in said structured document at time series for a plurality of number of times;
a storage section stores the contents or management information of the regions acquired by the read section;
a comparison and check section compares the contents or management information of the corresponding regions among the contents or management information of the regions acquired by the read section, and checks whether each of the regions has been updated based on a comparison result;
an update frequency calculation section calculates update frequency information for each of the regions based on a history of a check result of the comparison and check section; and
a key region determination section determines the key region from the plurality of regions included in said structure document based on the update frequency information.

9. An information processing apparatus for determining a key region from a structured document, the apparatus comprising:
a read section acquiring said structured document regularly or irregularly;
a division section dividing the structured document acquired by the read section into one or a plurality of regions;
a division result storage section temporarily storing a division result of the division section;
a comparison section comparing a content of said structured document acquired by said read section at one reading time with the content of said structured document acquired at a different reading time for each of said regions, and thereby checking whether each of the regions has been updated;
an update frequency storage section storing update information for each of the regions;
an update frequency calculation section calculating a new update frequency for each of the regions based on a previous update frequency of the each region and newly acquired information on update of said each region; and
a determination section determining that the region having a highest update frequency as the key region.

10. The information processing apparatus according to claim 9, wherein the new update frequency of each of said regions is calculated using an exponential average between the previous update frequency of said each region and a value included in the newly acquired information on the update of said each region.

11. An information processing apparatus for determining a key region from a structured document, the apparatus comprising:
a read section acquiring said structured document regularly or irregularly;
a division section dividing the structured document acquired by the read section into one or a plurality of regions;
a storage section temporarily storing a read result of the read section;
a comparison section comparing a content of said structured document acquired by said read section at one reading time with the content of said structured document acquired at a different reading time for each of said regions, and thereby checking whether each of the regions has been updated;
an update information storage section storing update information for each of the regions;
an update frequency calculation section calculating a new update frequency for each of the regions based on a previous update frequency of the each region and newly acquired information on update of said each region; and
a determination section determining that the region having a highest update frequency as the key region.

12. An information processing apparatus for determining a key region from a structured document, the apparatus comprising:
a read section acquiring said structured document regularly or irregularly;
a division section dividing the structured document acquired by the read section into one or a plurality of regions;
a conversion section converting a content of each of said divided regions into converted data;
a storage section temporarily storing the converted data;
a comparison section comparing the converted data obtained from said structured document that is acquired by said read section at one reading time with the converted data obtained from said structured document that is acquired at a different reading time, and thereby checking whether each of the regions has been updated;
an update information storage section storing update information for each of the regions;
an update frequency calculation section calculating a new update frequency for each of the regions based on a previous update frequency of the each region and newly acquired information on update of said each region; and
a determination section determining that the region having a highest update frequency as the key region.

13. An information processing apparatus for selecting a key region from a structured document including a plurality of regions, the apparatus comprising:
an attribute information generation section analyzing a control character designating a display structure of said structured document, and generating attribute information on each of said regions; and
a key region select section selecting the key region from among the plurality of regions by comparing said attribute information of the regions.

14. The information processing apparatus according to claim 13, wherein
said attribute information generation section uses a displayed area or a displayed area proportion of each of the regions as said attribute information, and
said key region select section selects the region having a large displayed area or a high displayed area proportion as the key region.

15. The information processing apparatus according to claim 13, wherein
said attribute information generation section uses a displayed position of each of the regions as said attribute information, and said key region select section selects the region of which is closest to a center of a display screen as the key region.

16. The information processing apparatus according to claim 13, wherein
said attribute information generation section uses a displayed area or a displayed area proportion and a displayed position of each of the regions as said attribute information, and
said key region select section selects one of the regions having a large displayed area or a high displayed area proportion, or the region the displayed position of which is closest to a center of a display screen as the key region.

17. The information processing apparatus according to claim 16, wherein
said key region select section selects the region having a high value given by Xα+Yβ as the key region, and wherein
X is a displayed area or a displayed area proportion of each of said regions;
Y is a distance between a center of said display screen and a center of each of the regions; and
α and β are weighting factors.

18. The information processing apparatus according to claim 16, wherein
said key region select section selects the region having a high value given by XY as the key region, and wherein
X is a displayed area or a displayed area proportion of each of said regions; and
Y is a distance between a center of said display screen and a center of each of the regions.

19. The information processing apparatus according to claim 13, wherein
said attribute information generation section uses a counting result of characters equal in type and size as said attribute information, and
said key region select section selects the region having a high counting value as the key region.

20. An information processing method for selecting a key region from a structured document including a plurality of regions, wherein
an attribute information generation section analyzing a control character designating a display structure of said structured document, and generating attribute information on each of said regions; and
a key region select section selecting the key region from among the plurality of regions by comparing said attribute information of the regions.
